(19) United States
(12) Patent Application Publication
(10) Pub. No.: US 2002/0188871 A1
(43) Pub. Date: Dec. 12, 2002

(54) System and method for managing security packet processing

(75) Inventors: Lee P. Noehring, Glendale, AZ (US); Chad W. Mercer, Gilbert, AZ (US)

Correspondence Address: Schwegman, Lundberg, Woessner & Kluth, P.A., P.O. Box 2938, Minneapolis, MN, 55402, US

(73) Assignee: Corrent Corporation

(21) Appl. No.: 10/160,330

(22) Filed: May 30, 2002

Related U.S. Application Data
(60) Provisional application No. 60/297,646, filed on Jun. 12, 2001.

(51) Int. Cl. H04L 9/00

(52) U.S. Cl. 713/201

(57) ABSTRACT

An IPSec packet processing system includes an IPSec manager to interface with an IPSec engine, to manage memory and to handle exceptions associated with IPSec packet processing. The IPSec manager may be a software module operating as part of a software stack on a host processor while the IPSec engine may perform IPSec packet processing. The IPSec manager may also initiate the negotiation of new keys, send ICMP messages for PMTU violations and log entries for exceptions.

PRIORITY CLAIM UNDER 35 U.S.C. 119

This patent application claims priority under 35 U.S.C. 119(e) claiming the benefit of earlier filed U.S. provisional patent application serial No. 60/297,646, filed Jun. 12, 2001.

### TECHNICAL FIELD

The present invention relates to the field of electronic communications, and particularly to Internet protocol (IP) communications implementing the IPSec security protocol.

### BACKGROUND

security protocols are used widely in modern day communications to provide security over different physical, logical or virtual mediums. One such security protocol is the IPSec Internet security protocol outlined in “Request for Comment” (RFC) 2401, 2402 and 2406. The IPSec security protocol may be implemented in either a tunneling mode or a transport mode. In a typical tunnel, unicast addresses are used to set up a “tunnel” between two nodes across a network. Tunneling enables one network to send data via another network's connections by encapsulating IP packets of one protocol within packets carried by the second network. IPSec security protocol communications are generally established between separate locations to protect data communications between the locations. The use of the IPSec security protocol may enable parties to establish a secure virtual private network (VPN).

One difficulty with processing packets that implement a security protocol, such as the IPSec security protocol, is that the processing requirements are such that high-speed packet communications are difficult to achieve. For example, IPSec packet processing implemented in a typical software processing system may not able be to readily achieve, for example, OC24 level communications and greater, which are desirable for many networks.

Another difficulty with the IPSec security protocol is that it requires the establishment and maintenance of security associations and security databases as well as handling packet exceptions. These operations consume processing power that may slow down IPSec packet processing making it all the more difficult to achieve higher speed IPSec packet communications.

Thus, there is a general need for a method and system for achieving high speed security packet communications. There is also a need for a method and system that efficiently establishes and maintains security associations for IPSec packet processing while achieving high-speed security packet communications. There is also a general need for a method and system that efficiently handle security protocol processing exceptions while achieving high speed security protocol packet communications.

### BRIEF DESCRIPTION OF THE DRAWINGS

The appended claims point out several different embodiments of the invention with particularity. However, the detailed description presents a more complete understanding of the present invention when considered in connection with the figures, wherein like reference numbers refer to similar items throughout the figures and:

FIG. 1 is a functional block diagram of an IPSec system architecture in accordance with an embodiment of the present invention;

FIG. 2 illustrates an IPSec fast path data flow in accordance with an embodiment of the present invention;

FIG. 3 illustrates the locations of fast path software in accordance with an embodiment of the present invention;

FIG. 4 illustrates the locations of slow path software in accordance with an embodiment of the present invention;

FIG. 5 illustrates IPSec fast path software stack operations in accordance with an embodiment of the present invention;

FIG. 6 is an example of an outbound security association database (SAD) table entry in accordance with an embodiment of the present invention;

FIG. 7 is an example illustrating outer IP and IPSec headers in accordance with an embodiment of the present invention;

FIG. 8 illustrates the addition of IPSec crypto engine control information in accordance with an embodiment of the present invention;

FIG. 9 illustrates incoming IPSec packet parsing in accordance with an embodiment of the present invention;

FIG. 10 is an example of an inbound security association database (SAD) table entry in accordance with an embodiment of the present invention;

FIG. 11 is an example of inbound pre-crypto log data in accordance with an embodiment of the present invention;

FIG. 12 is an example of inbound post-crypto log data in accordance with an embodiment of the present invention;

FIG. 13 is an example of outbound log data in accordance with an embodiment of the present invention;

FIG. 14 illustrates labeling in accordance with an embodiment of the present invention;

FIG. 15 illustrates a functional block diagram of an IPSec slow path software stack in accordance with an embodiment of the present invention;

FIG. 16 is a functional overview illustrating the operation of an Internet key exchange (IKE) module and an IPSec manager in accordance with an embodiment of the present invention;

FIG. 17 is an example of an IPSec memory management table and allocation of physical memory in accordance with an embodiment of the present invention;

FIG. 18 is an example of a security association (SA) key information block in accordance with an embodiment of the present invention;

FIG. 19 is an example of a security association database (SAD) free memory list in accordance with an embodiment of the present invention;

FIG. 20 is an example of a security association database (SAD) outbound hash table in accordance with an embodiment of the present invention;

FIG. 21 is an example of a security association database (SAD) inbound hash table in accordance with an embodiment of the present invention;

FIG. 22 shows examples of log registers in accordance with an embodiment of the present invention; and

FIG. 23 is a flow diagram of a procedure for adding new security association database (SAD) entries in accordance with an embodiment of the present invention.

### DETAILED DESCRIPTION

The following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and available equivalents.

The security processing systems and methods of the present invention may provide a robust hardware accelerated security protocol implementation suitable for wire speed networks of up to one giga-bit and greater. In one embodiment, a security processing system and method of the present invention may be suitable for optical carrier (OC-48) level networks, while in another embodiment, a security processing system and method of the present invention may be suitable for OC-192 level networks. In one embodiment, the security processing system may allow edge customer premise equipment to construct IPSec tunnels for virtual private network (VPN) traffic. Although the description here refers to embodiments of the present invention that may be suitable for the IPSec security protocol, other embodiments of the present invention are applicable to security processing in accordance with other security protocols.

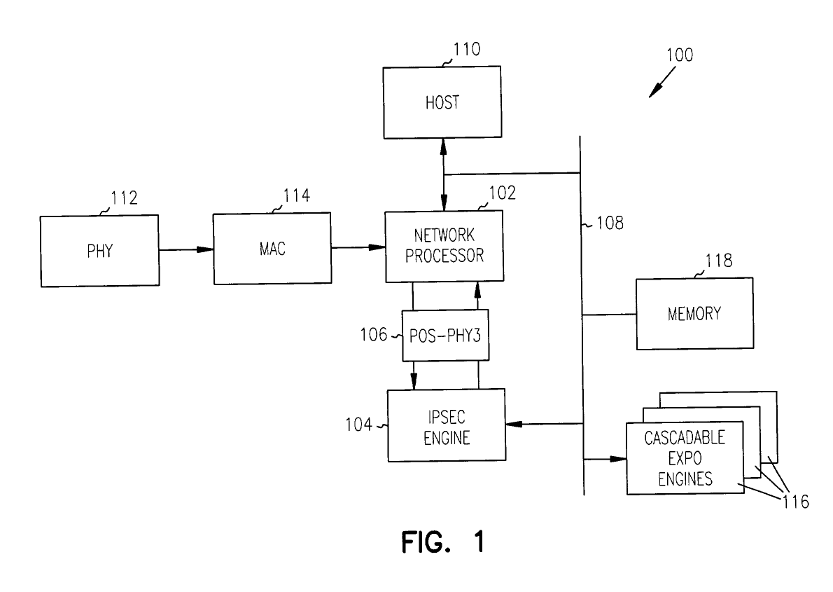

FIG. 1 is a functional block diagram of an IPSec system architecture in accordance with an embodiment of the present invention. IPSec system architecture 100 may illustrate an application specific integrated circuit (ASIC) implementation of the gateway IPSec tunnel protocol, although other implementations are suitable. Architecture 100 may include hardware acceleration engines and embedded RISC processor cores. Examples of a software architecture for the embedded RISC processor cores and external software interfaces are described herein. The embedded RISC processor software is referred to as firmware and/or ‘fast path’. Whereas, the external interface software is referred to as ‘slow path’.

The fast path software may provide a substantially complete IPSec packet capability for both inbound and outbound data traffic allowing network processing unit (NPU) 102 to send complete IP packets directly to IPSec engine 104 via interface 106. Interface 106 may comprise one or more Packet-Over-SONET Physical-Layer Three (POS/PHY3) type streaming interfaces, although Infiniband, UTOPIA, LX SPI-4 and other interface types may also be suitable. In one embodiment, interface 106 is comprised of RX and TX master streaming interfaces that are part of NPU 102, and RX and TX slave streaming interfaces that are part of IPSec engine 104.

NPU 102 may be perform IPSec policy checking for packets and may send packets to IPSec engine 104 for IPSec processing. In addition, NPU 102 may prepend an appropriate security association database (SAD) entry address to the beginning of outbound packets. Host processing unit (HPU) 110 may use an interface 108 to accesses resources on IPSec engine 104. Interface 108 may be a peripheral component interconnect (PCI) interface, and in one embodiment, may be a 32 bit, 66 MHZ PCI interface. Physical layer element (PHY) 112 may provide for the electrical and mechanical aspects relating to connectivity with an external network, and media access controller (MAC) 114 may provide for MAC layer communications between PHY 112 and NPU 102. In one embodiment, cascadable expo-engines 116 may couple with interface 108 for performing computation intensive operations including, for example, accelerated key exchange and digital signature computations. System 100 may also include one or more memories 118. Memories 118 may be allocated to IPSec engine 104 by host processor 110, may include executable software, and may store information for use in processing security packets by system 100.

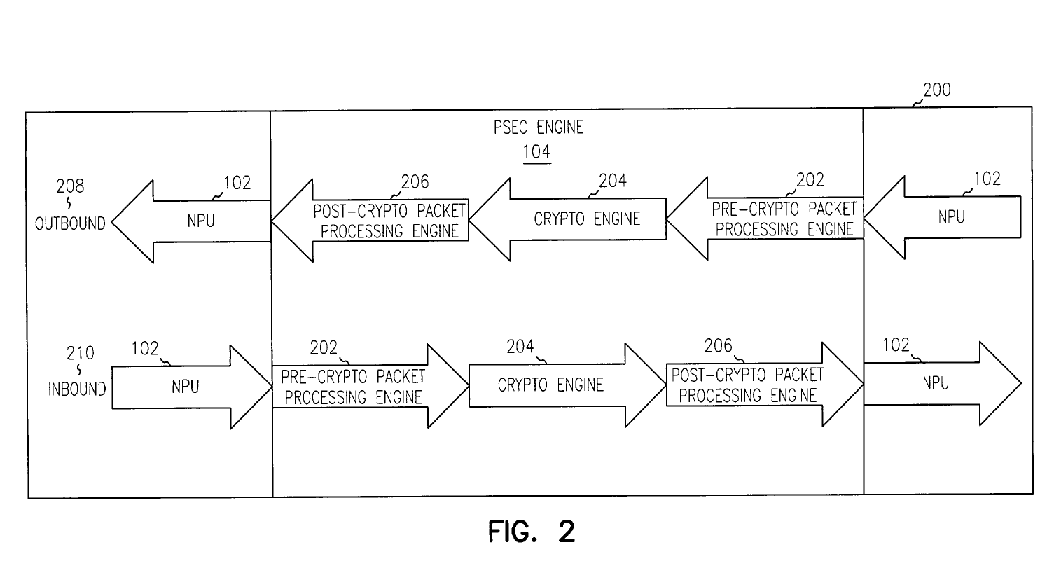

FIG. 2 illustrates an IPSec fast path data flow in accordance with an embodiment of the present invention. IPSec fast path data flow 200 illustrates the fast path data flow performed by IPSec engine 104 (FIG. 1) and shows that in one embodiment, IPSec Engine 104 (FIG. 1) may be comprised of three modules. Pre-crypto packet processing engine 202 may receive packets from NPU 102 and perform IPSec processing to prepare the packet for IPSec crypto core 204. For outbound packets 208, this may include reading the SAD entry into local memory, (e.g., memory 118 FIG. 1) updating the SAD entry (e.g., a byte count and a sequence number), performing lifetime checks, and building the outer IP header (with immutable fields for authentication header (AH) packets) including a checksum and a total length calculation. Preparing a packet for IPSec crypto core 204 may also include building the IPSec header and adding crypto control information prior to sending the packet to crypto engine 204. For inbound packets 210, preparing a packet for IPSec crypto core 204 may include parsing the packet and locating the IPSec header and the security policy index (SPI) number, and using the SPI number to locate, read and verify the SAD entry. Preparing an inbound packet for IPSec crypto core 204 may also include performing lifetime checks, zeroing mutable fields in outer IP header (for AH packets), and adding crypto control information prior to sending the packet to crypto engine 204.

Crypto engine 204 may perform encryption, decryption, and authentication as indicated by the security association (SA) entry. Post-crypto packet processing engine 206 may perform IPSec processing after crypto engine 204 has processed a packet and may send the packets back to NPU 102. For outbound packets 208, this may include setting correct values for mutable fields in outer IP header (for AH packets), and adding a message authentication code, such as an HMAC, to an AH header. For inbound packets 210, this may include verifying an HMAC (if included), reading the SAD entry back into local memory (e.g., memory 118 FIG. 1), performing a partial security policy check (e.g., to verify the inner IP source address is correct for tunnel). For inbound packets 210, this may also include performing an anti-replay check and update, updating lifetime information, and removing padding for encapsulated security protocol (ESP) padding when the padding exceeds a key block size. Crypto engine 204 may be configured with firmware/software (referred to as fast-path software), which may reside within IPSec engine 104 (FIG. 1).

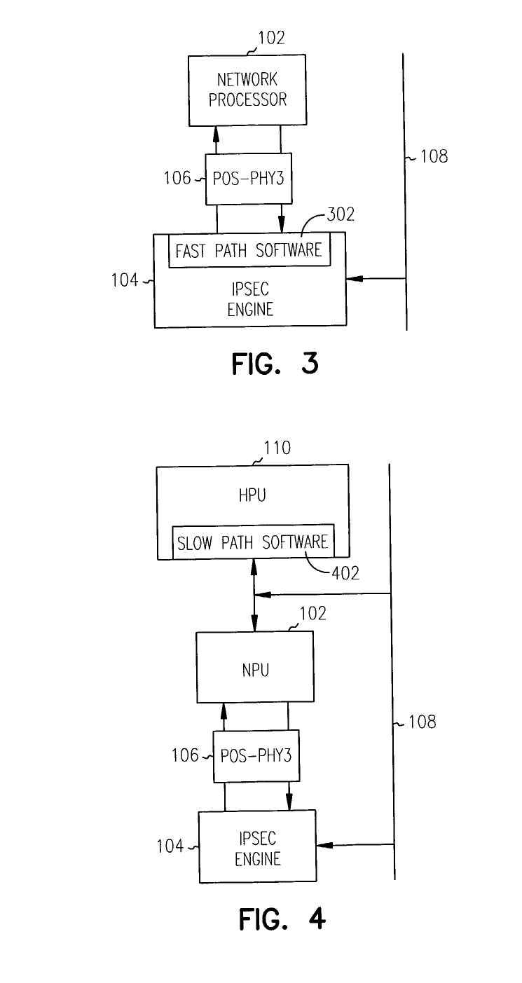

FIG. 3 illustrates the location of fast path software in accordance with an embodiment of the present invention. Fast path software 302 (including firmware) may reside within IPSec engine 104 as illustrated. Interface 108 may be provided for slow path functions. Examples of slow path functions include security association database (SAD) maintenance operations, path maximum transmission unit (PMTU) violations, and IPSec packet exception logging. In addition, interface 108 may provide an interface to a modulo engine of IPSec Engine 104 to allow internet key exchange (IKE) functions to utilize modulo engines, such as expo engines 116 (FIG. 1), for operations such as accelerated key exchange and digital signature computations.

FIG. 4 illustrates the location of slow path software in accordance with an embodiment of the present invention. Slow path software 402 may execute on HPU 110 and may use interface 108 to access resources on IPSec engine 104. In one embodiment, IPSec engine 104 may utilize drivers and API's to access this interface. Slow path software 402 for slow path functionality may be primarily operating system independent and reside within HPU 110.

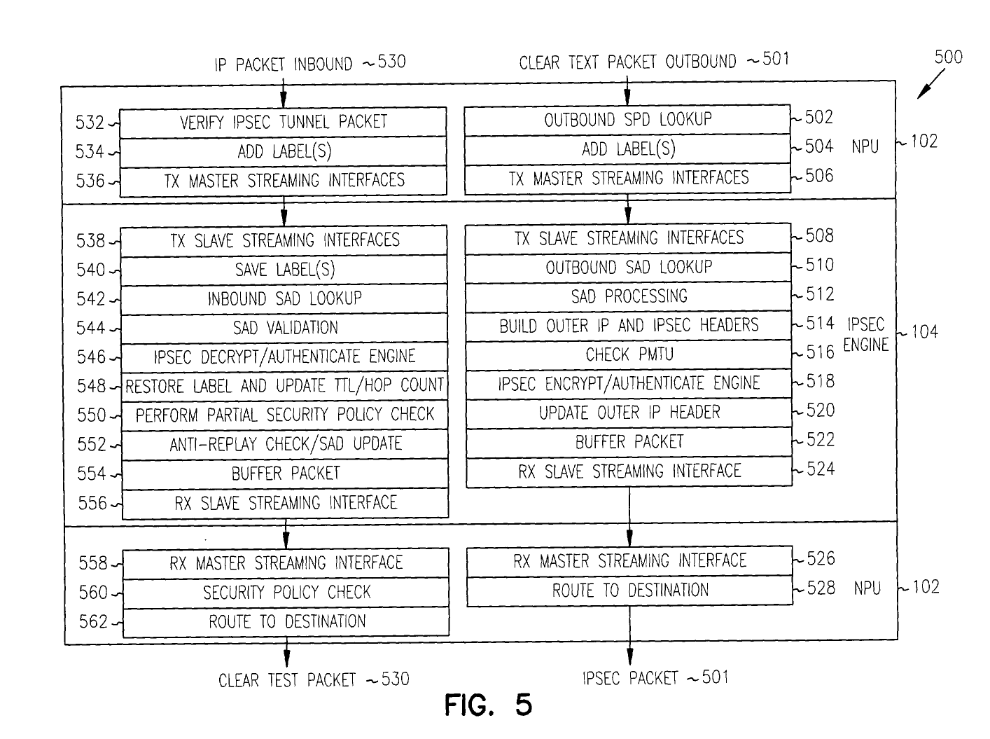

FIG. 5 illustrates IPSec fast path software stack operations in accordance with an embodiment of the present invention. IPSec Fast Path Software Stack 500 may be comprised of software and/or firmware modules illustrated as operations in FIG. 5. The software and/or firmware modules are configured to operate on NPU 102 and IPSec engine 104 as illustrated. FIG. 5 illustrates both outbound IPSec packet flow 501 and inbound packet flow 530 in accordance with embodiments of the present invention.

In one embodiment, IPSec engine 104 may include up to eight or more independent channels that may process up to forty or more independent packets at a time. In this embodiment, each channel may process at least five 64-byte packets at one time. Once a channel has been selected to process a new packet, that channel may be used to process the entire packet. The least busy channel, which may be determined by a TX slave streaming interface, may be selected to process the next available packet. NPU 102 may send complete packets to IPSec engine 104, which may buffer each packet before processing it. After processing, each packet may be sent back to NPU 102 via a RX slave streaming interface. Each packet may be returned to NPU 102 by way of the same channel that the packet was originally sent to. In one embodiment, a packet may be returned to NPU 102 after the entire packet has been processed allowing for it to be returned in its entirety without interruption. This is unlike convention systems in which packets are returned in 64 byte chunks.

IPSec engine 104 may be configured to operate in a dedicated or split configuration mode. In the dedicated mode, channels may be dedicated to inbound or outbound packets. In the split mode configuration, half of the channels may be used for inbound packets and half of the channels may be used for outbound packets.

Outbound IPSec packet flow 501 includes operations 502 through 506 and 526 and 258 which may be performed by NPU 102, and operations 508 through 524 which may be performed by IPSec engine 104. In operation 502, NPU 102 may perform security policy lookup using a security policy database (SPD) on outgoing packets. Outgoing packets may be sent to IPSec engine 104 when the result of the policy lookup indicates that the packet should be processed. In this case, the result of the policy may also indicate a SAD entry address (i.e., relevant to memory 118 allocated to IPSec engine 104), which NPU 102 may prepend to the beginning of the packet prior to sending the packet to IPSec engine 104. In addition, NPU 102 may prepend labels in operation 504 which may include between one to four labels or more. The labels may be 32-bit labels.

NPU 102 may use a TX master streaming interface in operation 506 to send IP packets to one of the split or dedicated streaming outbound channels of IPSec engine 104. TX master streaming interface may communicate with a TX slave Streaming interface of IPSec engine 104 in operation 508 to determine a channel available for the next packet. The TX slave streaming interface in operation 508 may throttle NPU 102 when the channels are too busy to accept a new packet. Once the TX slave streaming interface selects a channel, the channel may be used to receive and process the entire packet. Each channel may have external memory allocated for it to hold two or more complete packets, which may be indicated by a maximum transmission unit (MTU) for the router. As part of operation 508, the TX slave streaming interface may buffer an entire packet in an external memory of IPSec engine 104 allocated for the selected channel.

As part of operation 508, firmware of the fast path software stack may read packets from external memory, for example, in 64 byte chunks, to internal buffers (end of packet can be less). When IPSec engine 104 receives a new packet, the SAD entry address may be prepended to the packet. In addition, up to sixty bytes of label space may also be prepended to the beginning of the packet. In operation 510, the firmware may obtain the SAD entry address, save the labels to prepend to the outer IP header, and may perform an outbound SAD lookup. If the SAD entry address is invalid (e.g., when the msb is set) because the SAD entry has not been established yet, IPSec engine 104 may drop the packet, and create a log entry to notify an IKE element to establish a SAD entry for the specific policy. The log entry may include the invalid SAD entry address, which in this case may be the security policy index (after clearing the msb) that is relative to the security policy that the security associations need to be created for. Otherwise, IPSec engine 104 may use the SAD entry address provided by NPU 102 to locate and read the SAD entry from external memory into a local buffer. IPSec engine 104 may then verify that the data read is a valid SAD entry.

When the SAD entry is valid, IPSec engine 104 may process the SAD entry in operation 512. When the SAD entry is not valid, the packet may be dropped and an error log may be generated. Prior to reading the SAD entry into a local buffer, channel firmware of IPSec engine 104 may first obtain a semaphore for the SAD entry. This may prevent other channels from modifying the SAD entry while it is being verified and updated. The semaphore may be released after a sequence number and SA current byte count has been updated to allow other channels access to the same SAD entry in a timely fashion.

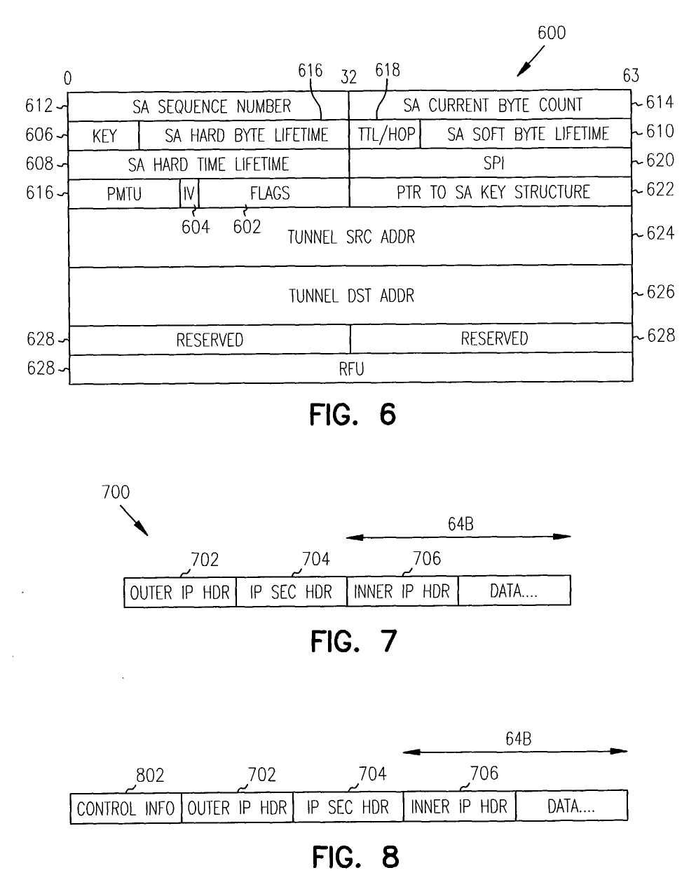

A SAD entry may contain information defining an outbound IPSec SA. FIG. 6 is an example of an outbound SAD table entry in accordance with an embodiment of the present invention. SAD table entry 600 includes outbound security association (SA) flags 602, which may be a 14-bit field and may include an anti-replay flag which if set, the SAD entry is to be terminated when sequence number overflows. Outbound SA flags 602 may also include a protocol flag, which if set, the IPSec protocol for outbound may be the ESP, otherwise the AH protocol. Outbound SA flags 602 may also include an IP version flag to indicate whether the tunnel IP address is an IPv4 address or an IPv6 address. Outbound SA flags 602 may also include a don't fragment flag which if set, a don't fragment bit in the outer IPv4 header is set and may be the default. Outbound SA flags 602 may also include an extra padding flag to indicate that additional padding is added to an ESP trailer and should be accounted for in the outer IP header total length field. Outbound SA flags 602 may also include a hashing flag to indicate when hashing is to be performed for an ESP packet and when a MAC field is to be added to end of packet. Outbound SA flags 602 may also include an encryption flag to indicate when encryption is to be performed for an ESP packet and to indicate that field 604 is valid. Outbound SA flags 602 may also include a TTL/hop flag to indicate when a TTL/hop field is to be copied from the SAD entry or from the inner header. Outbound SA flags 602 may also include a mode flag to indicate when an ESP transport mode or a tunnel mode is used. Outbound SA flags 602 may also include a pre-crypto error flag, which may be reserved by the channel firmware to indicate that an error was detected during pre-crypto processing. The pre-crypto error flag does not need to be written to the SAD entry, but may set in flags field 602 when the flags are copied to a post-crypto save state for the channel. IV field 604 may be a two-bit field to indicate the IV size. IV field 604 may be valid when the encryption fag is set. Key field 606 may be an eight-bit field used to verify that the SAD entry specified by NPU 102 is a valid SAD entry. Key field 606 may, for example, contain the SAD entry address in bits 8-15.

As part of the SAD processing of operation 512 (FIG. 5), the firmware may perform a hard lifetime (time and byte count) check if necessary. If the hard lifetime values in field 608 in SAD entry 600 are not zero, the lifetime check may be performed. If the lifetime check fails, the packet may be dropped and a message may be logged for HPU 102. The firmware may also perform a soft byte lifetime check as part of operation 512. For example, when the soft lifetime value in field 610 is not zero, a soft byte lifetime check may be performed. If the soft byte lifetime has been exceeded, a log entry may be created for HPU 102 to notify the IKE to reestablish the SAD entry.

As part of operation 512, the firmware may increment the SA sequence number in field 612. If the sequence number rolls over the SA may no longer be valid (as indicated by a anti-replay flag in field 602). If rollover is not allowed, the firmware may drop the packet and log an event for HPU 102 to possibly refresh the SAD entry. As part of operation 512, the firmware may calculate the total byte length count for the outbound packet with the additional headers including the IV and trailers for ESP packets. This value may be used to increment the SAD entry's current byte count field for AH packets. For ESP packets, the current byte count in field 614 may be incremented by the total byte length minus the length of the outer IP header plus the length of the ESP header.

Outbound SAD table entry 600 (FIG. 6) may also include hard byte lifetime field 616, TTL/hop field 618, SPI number field 620, tunnel source address field 624, tunnel destination address field 626 and reserved fields 628.

Firmware of IPSec engine 104 may also build outer IP And IPSec headers in operation 514 (FIG. 5). FIG. 7 is an example illustrating outer IP and IPSec headers in accordance with an embodiment of the present invention. Outer IP header 702 may be constructed using information found in SAD entry 600 (FIG. 6). For IPv4 packets, a checksum value may be calculated and written to the outer header. For AH protocol packets, the outer header's mutable fields may be removed and saved for later. As part of operation 514, IPSec header 704 may be created (for either AH or ESP packets) using information found in SAD entry 600. Outer IP header 702 and IPSec header 704 may be prepended to the packet. In addition, the labels that were prepended to the inner IP header may be prepended to the outer IP header with, for example, a status field (indicating success) being inserted after the first label. The status field may be updated later if an error occurs.

In operation 516 (FIG. 5), the firmware of IPSec engine 104 may also check the tunnel's packet maximum transmission unit (PMTU) value. With the addition of the outer IP and IPSec headers 702, 704, new IP packet 700 may exceed the tunnel's PMTU value defined in field 616 (FIG. 6). If this occurs, the firmware may drop the packet and log an error message for HPU 102 (along with the newly adjusted PMTU value). HPU 102 may then notify the originating client via an Internet control message protocol (ICMP) message to readjust its PMTU value.

In operation 518 (FIG. 5), an IPSec encryption or authentication engine of IPSec engine 104 may process an entire packet in one of its outbound channels. When pre-crypto processing has been completed for a packet, IPSec engine 104 may start moving the packet into the corresponding crypto engine channel in byte chunks of a predetermined size (e.g., 64 byte chunks). The end of the packet may have less than 64 bytes.

FIG. 8 illustrates the addition of IPSec crypto engine control information in accordance with an embodiment of the present invention. Control information 802 is prepended to the beginning of the packet prior to processing by IPSec engine 104. Control information 802 may contain a total packet length, a byte-offset to the start of cipher and/or hash, a flow direction, and a pointer to an SA key structure. The SA key structure may include the keys for encryption and/or authentication along with control information that indicates the encryption algorithm (e.g., DES, 3DES, AES) and/or authentication algorithm (MD-5 or SHA-1) IPSec crypto engine 104 may apply. When a crypto engine channel is finished processing the data chunk, it may send it to the channel's output buffer at which time the post-crypto processing phase may begin.

A post-crypto processing phase of outbound IPSec packet flow 501 includes updating the Outer IP Header in operation 520. For AH packets, when, for example, the first chunk (e.g., 64 byte) of a packet is received in the output buffer, the firmware may replace the mutable fields with the information that was saved earlier. In addition, the firmware may retrieve the total length from inner IP header 706 (FIG. 7).

Outbound IPSec packet flow 501 also includes buffering the packet in operation 522. The first chunk of the packet, along with the remaining chunks of the packet may then be copied into an external buffer allocated for the selected channel. When the entire packet has been processed, the firmware may check the status from the crypto engine. The status, for example, may be a 32-bit data-word (DWORD) prepended to the end of the packet on a 32-bit boundary. When the status indicates that the crypto engine detected an error, the packet may be dropped and a log entry may be created for HPU 102. In addition, a status field inserted after the first label prepended to the packet may be updated and the label and status information may be sent to NPU 102. When no error is indicated, the firmware may notify the RX master streaming interface that the entire packet is ready to be returned to NPU 102. For AH packets, an HMAC may be inserted into the AH header prior to indicating that the packet is ready for the RX master streaming interface.

When a packet is ready for the RX master streaming interface, the RX slave streaming interface in operation 524 may prioritize the packet based on a first come first serve protocol scheme. Therefore, if the RX master streaming interface is busy sending out a large packet, at which time multiple packets are completing on different channels, the RX slave streaming interface may select the next channel to send based on the which packet completes first. As part of operation 524, when a packet is selected for the streaming interface, the RX slave streaming interface may read the entire packet from memory and send it across the RX slave streaming interface, for example, in 64-byte chunks.

In operation 526, NPU 102 may use the RX master streaming interface to receive packets from IPSec engine 104. The RX slave interface may indicate the channel the packet is sent from. As part of operation 526, the RX master streaming interface may throttle the slave interface if NPU 102 is not ready to receive data. In operation 528, NPU 102 may route the outbound packet to its destination.

FIG. 5 also illustrates inbound IPSec packet flow 530 in accordance with an embodiment of the present invention. Operations 532-536 and 558-562 of inbound IPSec packet flow 530 may be performed by NPU 102, and operations 538-556 of inbound IPSec packet flow 530 may be performed by IPSec engine 104. In operation 532, NPU 102 may first determine if an inbound packet is an IPSec packet. If an inbound IP packet has the destination address for NPU 102, NPU 102 may parse the packet to determine if it is an IPSec tunnel packet. For example, the protocol or next header value may indicate whether the packet is an ESP packets or an AH packets. If NPU 102 determines that the packet is an IPSec tunnel packet, NPU 102 may prepend one or more labels to the front of the packet in operation 534. The labels may be 32-bit labels.

In operation 536, NPU 102 may send the packet to IPSec engine 104 via the TX master streaming interface with the prepended labels. As part of operation 536, NPU 102 may use the TX master streaming interface to send IP packets to one of the split or dedicated streaming inbound channels of IPSec engine 104. In operation 538, the TX master streaming interface may communicate with the TX slave streaming interface of IPSec engine 104 to determine the next channel that is available for the next packet. The slave streaming interface may throttle NPU 102 when the available channels are too busy to accept a new packet. As part of operation 538, the TX slave streaming interface may determine which channel may receive the next packet. Once the channel is selected, it may be used to receive and process the entire packet. Each channel may have external memory allocated for it to hold two or more complete packets, which may be indicated by the MTU for the router. The TX slave streaming interface may buffer the entire packet in external memory allocated for the selected channel.

As part of operation 538, the firmware operating on IPSec engine 104 may read packets from an external memory in chunks (e.g., 64-byte) to internal buffers. The end of packet may be smaller than the chunk size. In one embodiment, the internal buffer may hold up to three 64-byte chunks or more.

In operation 540, IPSec engine 104 may remove and save labels when it receives the beginning of a packet, and may start parsing the outer header for pertinent information as part of inbound SAD lookup in operation 542. The firmware operating on IPSec engine 104 may obtain the IP version number, IPSec protocol type, header and payload lengths, and source/destination addresses from the outer header. IPSec packets that have invalid or missing header information may be dropped and an exception logged. The firmware may also parse the packet for the IPSec header to retrieve the SPI and sequence number. In operation 542, an SAD look-up may be performed using the SPI value.

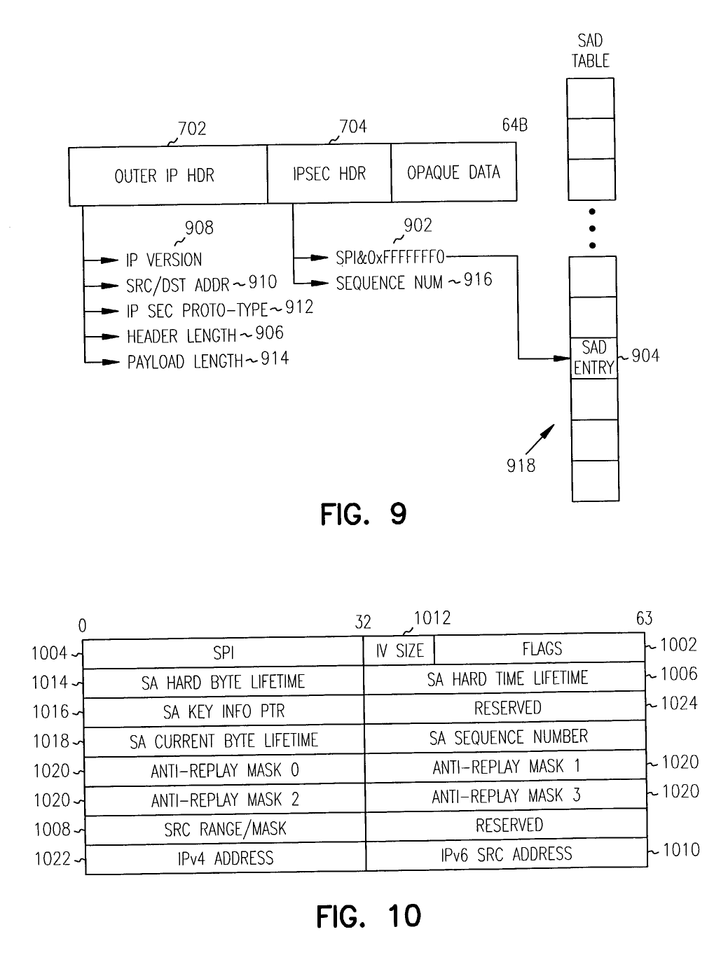

FIG. 9 illustrates incoming IPSec packet parsing in accordance with an embodiment of the present invention. Outer IP header 702 may include, among other things, IP version number 908, tunnel source and/or destination address 901, IPSec prototype 912, header length 906 and payload length 914. IPSec header 704 may include, among other things, SPI value 902 and sequence number 916. In one embodiment, some predetermined portion of bits (e.g., bits 4-31) of SPI value 902 may represent an SAD address pointer for inbound SA entry 904 of SAD table 918 for the packet. The SAD address may be on a 16-byte boundary. The other portion of bits (e.g., bits 0-3) of SPI value 902 may be incremented (e.g., rolling over at 15) with each new SAD entry that is reusing an SAD address. It may then be used to detect an old packet that maps to SAD address that is being reused. The inbound SA table entry 904 may be read into an internal buffer.

FIG. 10 is an example of an inbound SAD table entry in accordance with an embodiment of the present invention. Among other things, inbound SAD table entry 1000 includes flag field 1002 to store inbound SA flags. The inbound SA flags may include an anti-replay flag to indicate when anti-replay service is enabled. The inbound SA flags may also include a protocol flag to indicate whether the IPSec protocol is ESP or AH protocol. The inbound SA flags may also include a hashing flag that may be valid for ESP and may indicate when authentication is included with the packet. The inbound SA flags may also include an encryption flag that may be valid for ESP packets and may indicate when encryption has been performed on the packet. The inbound SA flags may also include a range flag to indicate whether a source range/mask in field 1008 is a range or a mask, such as a subnet mask. The inbound SA flags may also include an IPv6 flag to indicate whether the source address in field 1010 is IPv6 address or an IPv4 address. The inbound SA flags may also include a mode flag to indicate whether ESP transport mode or tunnel mode is used. The inbound SA flags may also include a pre-crypto error flag that may be reserved by channel firmware to indicate that an error was detected during pre-crypto processing. The pre-crypto error flag does not need to be written to the SAD entry, but may be set in the flags field when the flags are copied to the post-crypto save state for the channel.

Inbound SAD table entry 1000 may also include SPI number field 1004, IV field 1012, SA hard lifetime field 1006, SA hard byte lifetime field 1014, SA key information pointer field 1016, SA current byte lifetime field 1018, and one or more anti-replay mask fields 1020. Inbound SAD table entry 1000 may also include IPv4 source address field 1022 and IPv6 source address field 1010. Inbound SAD table entry 1000 may also include reserved fields 1024.

As part of operation 544 (FIG. 5), IPSec engine 104 processes outer IP headers 702 (FIG. 9). The firmware may verify that the incoming packet's outer header is valid. For both IPv6 and IPv4 addresses, the firmware may save the outer header's total length 906 and may clear the mutable fields for AH packets. The firmware may verify that the SAD entry is valid by verifying that SPI number 1004 in SAD entry 1000 is correct. A lifetime check may be performed when the hard lifetime values in field 1006 are non-zero. When the lifetime check detects that the SAD entry has expired, the packet may be dropped and an error log may be created for HPU 102. When the lifetime check passes, the packet may be processed.

At this point in inbound packet flow 530 (FIG. 5), the inbound packet may be ready to be sent to crypto engine 204 of IPSec engine 104 for processing as part of operation 546 (FIG. 5). The firmware may prepend SA control information 802 (FIG. 8) to a first chunk of the packet prior to sending it. Control information 802 may include the total packet length, byte-offset to hash and/or decrypt starting points, flow direction (e.g., inbound or outbound), and a pointer to the SA key structure for the current SAD entry. Crypto engine 204 may remove outer IP header 702, and IPSec header 704 and any trailers. Crypto engine 204 may also remove any standard padding.

In some instances, ESP based SAs may specify additional padding to be appended to an encrypted IP packet. In this case, the firmware may remove this padding. In one embodiment, the padding may be removed by reading the decrypted inner IP header's payload length field, and by comparing it against the expected length (i.e., based on the outer IP header length and key lengths). The firmware may detect where the padding starts prior to decrypting the ESP trailer, and may remove the pad bytes prior to sending the pad bytes to NPU 102.

After crypto engine 204 operates on the packet in operation 546 (FIG. 5), the label tags may be restored to the inner IP header in operation 548. Each chunk of a packet may be written to the channel output buffer after processing by crypto engine 204. For the first chunk, the firmware may restore the label tags to the beginning of the packet (e.g., the inner IP packet). In addition a status word, which may indicate success, may be inserted after the first label. If an error is detected at a later time, the status word may be updated accordingly.

As part of operation 548, the TTL/hop count in field 618 (FIG. 6) may be updated. When the inner IP header is written to the channel output buffer from crypto engine 214, the firmware may decrement the TTL/hop count value. For IPv4 packets, the firmware may recalculate the header checksum after decrementing the TTL/hop count value. After the entire packet has been processed, the firmware may check the status from crypto engine 204. The status may be, for example, a 32-bit DWORD that may be prepended to the end of the packet on a 32-bit boundary. If the status indicates that the crypto engine detected an error (including, for example, an HMAC compare error), the packet may be dropped and a log entry may be created for HPU 102. In addition, the status field inserted after the first label that is prepended to the packet may be updated and the label and status information may be sent to NPU 102.

In operation 550, a partial inbound security policy check is performed. When a crypto error (including a HMAC failure) is not indicated, the firmware may perform a partial security policy check that may verify the IP source address of the inner IP header with the SAD entry. If the policy check fails, the packet may be dropped, and an error log may be sent to the HPU.

In operation 522, an anti-replay check may be performed when the partial inbound security policy check of operation 550 is successful. If the anti-replay check is unsuccessful, the packet may be dropped and an error log may be sent to HPU 102. As part of operation 552, the SAD entry is updated. When the anti-replay check passes, the firmware may update the current byte count and the anti-replay data for the SAD entry.

In operation 554, the packet is buffered. The first chunk of the packet, which may be a 64-byte chunk, along with remaining chunks of the packet may then be copied into an external buffer allocated for the selected channel. In one embodiment, the firmware may notify the RX master streaming interface when the entire packet has been processed and is ready to be returned to NPU 102.

In operation 556, the RX slave streaming interface may prioritize the packet based on a first come first serve protocol scheme. When the RX master streaming interface is busy sending out a large packet, at which time multiple packets complete on different channels, the RX slave streaming interface may select the next channel based on the which packet completed first. When a packet is selected for the streaming interface, RX slave interface may read the entire packet from memory and send it across the streaming interface, for example, in 64-byte chunks.

In operation 558, NPU 102 may use the RX master streaming interface to receive packets from IPSec engine 104. RX slave streaming interface may indicate which channel a packet may be sent from. The RX master streaming interface 558 may throttle the RX slave streaming interface when NPU 102 is not ready to receive data. In operation 560, a security, policy check is performed and in operation 562, NPU 102 may route the packet to its destination.

Accordingly, architecture 100 (FIG. 1) may fully support an IPSec tunnel mode. In another embodiment, architecture 100 may support an IPSec transport mode, including at least ESP transport mode. In the transport mode embodiment, the ESP header and trailer may be removed for inbound ESP transport packets, and may be added for outbound ESP transport packets. The total length field in the IP header may be updated (for both IPv4 and IPv6 packets) and a new checksum may be calculated for IPv4 packets. In addition, lifetime checks, anti-replay checks, and sequence number rollover checks may be performed as they are for tunnel packets in the tunnel mode embodiment.

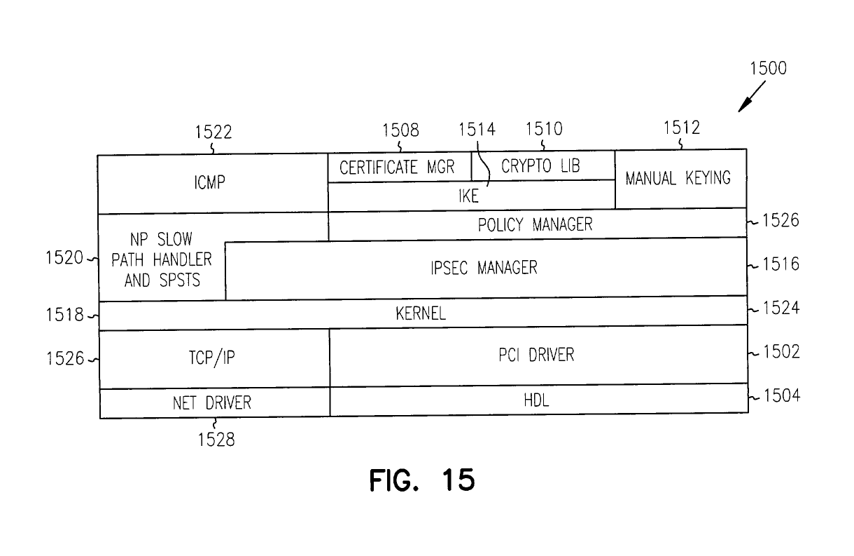

Architecture 100 may also perform exception logging as part of processing IPSec packets. An IPSec manager module, which may be part of an IPSec slow path software stack (see FIG. 15) operating on a processor such as NPU 102 or HP 110, may perform the exception logging. The IPSec manager may allocate memory, as described below, for IPSec engine 104 for the logs and initialize the log pointers. IPSec engine 104 may generate logs entries and add the log entries to the circular log queue using a log write pointer. An interrupt, such as a PCI interrupt may be signaled when a time critical log is added to the log buffer. For non-critical log entries, the interrupt may be generated after a predetermined threshold is crossed. A semaphore to prevent multiple processes from updating it at the same time may protect the log write pointer. The packet being processed may be dropped when a log entry is generated. In addition, an error status indication may be returned to NPU 102 (e.g., via a interface 106) along with labels prepended to the packet. The IPSec manager may remove log entries from the circular log queue using a log read pointer, and may include a date/time value with the audited event.

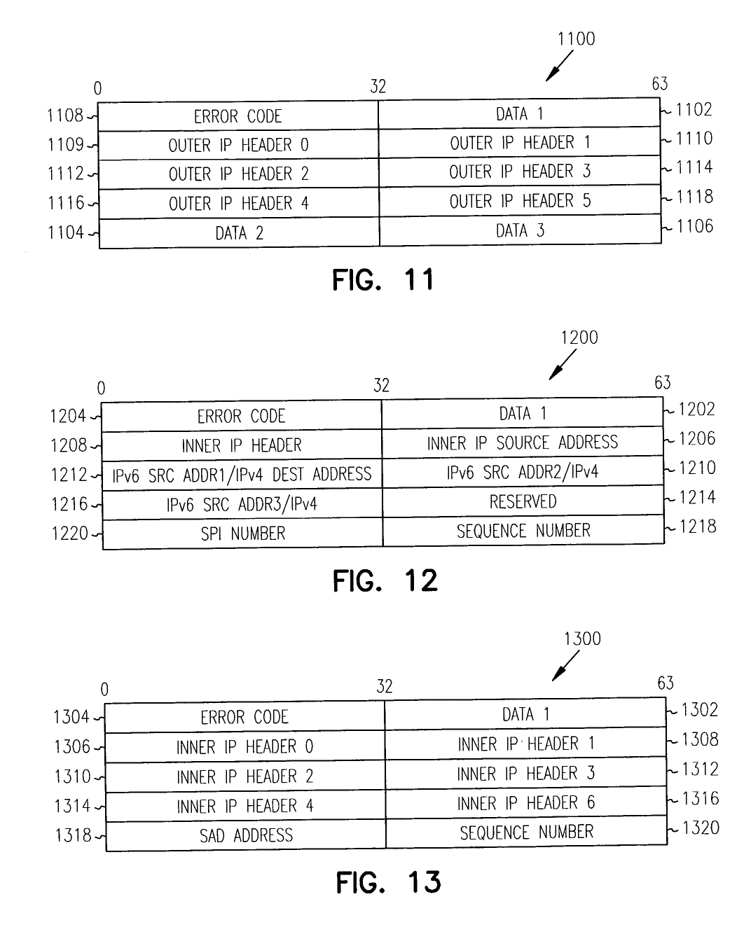

FIG. 11 is an example of inbound pre-crypto log data in accordance with an embodiment of the present invention. Inbound pre-crypto log data 1100 may include data 1 field 1102, data 2 field 1104, and data 3 field 1106, which may depend on an error code and may be unused depending on the error. Inbound pre-crypto log data 1100 may also include error code field 1108 and outer IP header fields 1108 through 1118. Examples of inbound pre-crypto errors include an inbound PL3 error when the TX slave streaming interface detects an error. Data 1 field 1102 may store a PL3 error code, and the IPSec manager may record statistical information. Another example of an inbound pre-crypto error is when the input DMA detects an error correcting code (ECC) error while transferring a SAD entry. Data 1 field 1102 may store the SPI number and the IPSec manager may notify an IKE element to refresh the SAD entry.

Another example of an inbound pre-crypto error is an inbound fragment error when a fragmented IPSec packet is received. In this case, the IPSec manager may record statistical information. Another example of an inbound pre-crypto error is when an inbound packet is received without an IPSec header. In this case, data 1 field 1102 may store the protocol and the IPSec manager may record statistical information. Another example of an inbound pre-crypto error is when the inbound packet is received without IPSec header. In this case, the IPSec manager may record statistical information. Another example of an inbound pre-crypto error is when a plaintext IP packet is received without a TCP/UDP header. In this case, data 1 field 1102 may store the protocol and the IPSec manager may record statistical information. Data 2 field 1104 may store the outer IP header.

Another example of an inbound pre-crypto error is when the IPSec packet is received with an invalid SPI number. In this case, data 1 field 1102 may store the SPI Number and the IPSec manager may record statistical information. Another example of an inbound pre-crypto error is when the SA hard byte lifetime has expired. In this case, data 1 field 1102 may store the SPI number, data 2 field 1104 may store the sequence number, data 3 field 1106 may store the current byte count, and the IPSec manager may update statistical information and notify the IKE element to refresh or remove the SAD entry. Another example of an inbound pre-crypto error is when the SA hard time lifetime has expired. In this case, data 1 field 1102 may store the SPI Number, data 2 field 1104 may store the sequence number, data 3 field 1106 may store the current byte count, and the IPSec manager may update statistical information and notify the IKE element to refresh or remove the SAD entry.

FIG. 12 is an example of inbound post-crypto log data in accordance with an embodiment of the present invention. Inbound post-crypto log data table 1200 may include data 1 field 1202, error code field 1204, inner IP source address field 1206, inner IP header field 1208, IPv6 source address/IPv4 destination address fields 1210, 1214 and 1216, a reserved field 1214, a sequence number field 1218 and an SPI number field 1220. One example of an inbound post-crypto error is an inbound post SAD ECC error when an input DMA of IPSec engine 104 detects an ECC error while transferring the SAD entry. In this case, the IPSec manager may notify the IKE element to refresh the SAD entry. Another example of an inbound post-crypto error includes an inbound old packet error when an inbound packet that had a sequence number outside of the replay window. In this case, the IPSec manager may record statistical information.

Another example of an inbound post-crypto error includes an inbound replay error when an IPSec packet is received with a sequence number that has already been received. In this case, the IPSec manager may record statistical information. Another example of an inbound post-crypto error includes an inbound crypto error when the status from crypto engine 204 (FIG. 2) indicates an error. In this case, data 1 field 1202 may store a crypto engine status word, and the IPSec manager may record statistical information. Another example of an inbound post-crypto error includes an inbound policy failure error when the partial inbound policy check fails. In this case, the IPSec manager may record statistical information. Another example of an inbound post-crypto error includes an inbound ESP offset error when the IP header of the packet contains options. In this case, data 1 field 1202 may store the ESP offset and the IPSec manager may record statistical information.

FIG. 13 is an example of outbound log data in accordance with an embodiment of the present invention. Outbound log data table 1300 may include data 1 field 1302, error code field 1304, inner IP header fields 1306 through 1316, SAD address field 1318 and sequence number field 1312. Table 1300 may be utilized for both pre-crypto errors logging as well as post crypto error logging for outbound packets. One example of an outbound pre-crypto error may include an outbound invalid SAD error when the SAD entry address received from NPU 102 is invalid. In this case, the IPSec manager may update statistical information. Another example of an outbound pre-crypto error may include an outbound SA byte expired error when the SA hard byte lifetime has expired. In this case, data 1 field 1302 may store the current byte count, and the IPSec manager may update statistical information and notify the IKE element to refresh SAD entry.

Another example of an outbound pre-crypto error may include an outbound SA soft byte expired error when the SA soft byte lifetime has expired. In this case, data 1 field 1302 may store the current byte count and the IPSec manager may update statistical information and notify the IKE element to refresh or remove the SAD entry. Another example of an outbound pre-crypto error may include an outbound SA time expired error when the SA hard time lifetime has expired. In this case, data 1 field 1302 may store the current byte count and the IPSec manager may update statistical information and notify the IKE element to refresh or remove the SAD entry. Another example of an outbound pre-crypto error may be when the PMTU has been exceeded. In this case, data 1 field 1302 stores a new MTU value, and the IPSec manager may update statistical information and create an ICMP message to send new PMTU value to the source IP address. Another example of an outbound pre-crypto error may include an outbound sequence overflow error when the overflow flag is set, and the sequence number has overflowed. In this case, data 1 field 1302 may store the current byte count, and the IPSec manager may update statistical information and notify a policy manager to either refresh or remove the SAD entry. Another example of an outbound pre-crypto error may include an outbound no SAD error when the SAD entry for the policy has not been established yet. In this case, data 1 field 1302 may store the security policy index, and the IPSec manager may notify a policy manager to establish the SA. The security policy index may be a 32-bit value with msb set prepended to front of packet. When a new SAD entry is established prior to updating the search table, this error may not necessarily occur. Another example of an outbound post crypto error may include an outbound crypto error when the status from the crypto engine indicates an error. In this case, data 1 field 1302 may store the crypto status word and the IPSec manager may record statistical information.

In one embodiment of the present invention, the firmware on IPSec engine 104 (FIG. 1) may be configured to handle fragments. IPSec engine 104 (FIG. 1) may handle fragmented IP packets when they have been fragmented prior to having IPSec applied to them. In the case of a fragmented IP packet, IP packet's fragment offset may not be zero and the UDP header may not be available. Accordingly, port information may not be available. In this embodiment, IPSec engine 104 may adjust the PMTU to prevent fragmentation. When IP packets are fragmented after entering an IPSec tunnel, the fragmented packets may be reassembled prior to being passed to IPSec engine 104. When a gateway cannot reassemble IP packets, the don't fragment bit may be set in the IP header.

In one embodiment, IPSec engine 104 (FIG. 1) may treat fragmented IP packets similar to non-fragmented packets when the port information is not required for a security policy match. If port information is required for the security policy match and is not available due to fragmentation, IPSec engine 104 (FIG. 1) may drop the packet and log a message. The message may indicate that an ICMP PMTU message should be sent to the host with the source IP address to avoid future fragmentation. The ICMP PMTU message may convey that the destination is unreachable due to fragmentation needed and that DF set (e.g., for IPv4 packets) or due to the packet being too big (e.g., for IPv6 packets).

In one embodiment of the present invention, the firmware on IPSec engine 104 (FIG. 1) may be configured to handle labels. NPU 102 may prepend one to fifteen labels (e.g., 32-bit labels) to the beginning of each packet. In addition, for outbound packets, NPU 102 may insert one field (e.g., a 32-bit field) indicating the SAD address after the labels. The number of labels prepended to each packet may be a system configurable option. In one embodiment, NPU 102 may prepend the same number of labels to each packet and include padding for packets that require fewer labels.

For inbound packets, the firmware may save the labels and add them to the beginning of the inner IP header after the crypto engine has processed the packet. In addition, the firmware may insert a status word after the labels. For outbound packets, the firmware may save the labels and obtain the SAD address from the word following the labels. The firmware may add the IPSec and outer IP header to the packet and prepend the labels to the outer IP header. In addition, the firmware may insert a status word after the labels, which may replace the SAD address.

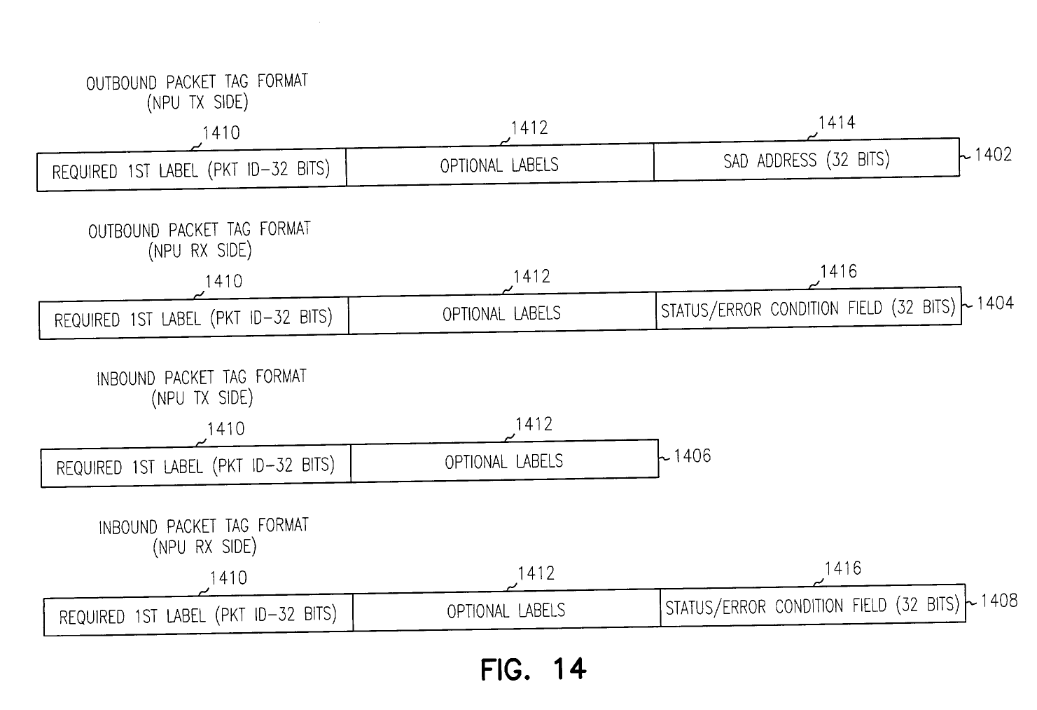

FIG. 14 illustrates labeling in accordance with an embodiment of the present invention. Tag format 1402 illustrates an example outbound packet tag format for the TX side of NPU 102, tag format 1404 illustrates an example outbound packet tag format for the RX side of NPU 102, tag format 1406 illustrates an example inbound packet tag format for the TX side of NPU 102, and tag format 1408 illustrates an example inbound packet tag format for the RX side of NPU 102. Field 1410 may be a first 32-bit label and may be a packet ID. Field 1410 may be specific to NPU 102 and may be set by NPU 102 for packet identification. A portion of the bits may be available for other use and another portion of the bits may be reserved by IPSec engine 104. Option tag headers field 1412 may include information specific to NPU 102. SAD address field 1414 may have a value set by NPU 102 to the SAD address for IPSec engine 104. Status/error condition fields 1416 may indicate post packet process messages set by IPSec engine 104.

FIG. 15 illustrates a functional block diagram of an IPSec slow path software stack in accordance with an embodiment of the present invention. IPSec slow path software stack 1500 may execute in a real-time environment on a host processor, such as host processor 110 (FIG. 1) of architecture 100 (FIG. 1) although other processors and architectures are also suitable. In accordance with the embodiment of architecture 100 (FIG. 1), slow path software stack 1500 may communicate, for example, with IPSec engine 104 (FIG. 1) through an interface, such as interface 108 (FIG. 1) through driver 1502 and hardware dependent layer (HDL) 1504. IPSec slow path software stack 1500 may deliver IPSec slow path functionality to work in conjunction with the IPSec engine 104 (FIG. 1) to provide a substantially full IPSec solution.

IPSec slow path software stack 1500 may include IKE (Internet Key Exchange) elements comprised of software modules for establishing IPSec security associations (SAs). The IKE modules may include policy manager 1506, certificate manager module 1508, crypto library module 1510, manual keying module 1512 and IKE 1514. Policy manager module 1506 may be the primary interface between the IKE modules and IPSec manager 1516. Policy manager module 1506 may administer an IPSec security policy database (SPD), and may provide an administrative interface to add, modify and delete security policies. Policy manager 1506 may request SPI numbers from IPSec manager 1516 for new inbound security associations (SA). Policy manager 1506 may notify IPSec manager 1516 of a new SPD entry, notify IPSec manager 1516 of new inbound and outbound security associations, and notify IPSec manager 1516 of inbound and outbound security associations that are no longer valid. Policy manager 1506 may also receive requests from IPSec manager 1516 of outbound security associations that have exceeded soft lifetime and need to be refreshed, receive requests from IPSec manager 1516 of inbound and outbound security associations that have exceeded a hard lifetime and need to be refreshed or removed, and receive notification from IPSec manager 1516 of security policies that may need security associations established.

Certificate manager module 1508 may be used by IKE module 1514 during establishment of IKE security associations. Crypto library module 1510 may be used by IKE 1508 to perform crypto and hashing functions when establishing IKE and IPSec security associations. Hardware accelerators may accelerate these functions. Manual keying module 512 may provide information to allow specific policies to use static tunnels.

IPSec manager 1516 may be the primary interface to IPSec engine 104 and may also provide an interface to the other software modules to provide a substantially complete IPSec solution. IPSec manager 1516 may use driver 1502 and HDL 1504 to access IPSec engine 104. IPSec manager 1516 may initialize IPSec engine 104, copy IPSec firmware into memory for IPSec engine 104, and perform IPSec memory management. As part of memory management, IPSec manager 1516 may allocate memory for SAD entries (e.g., packet processing blocks and key information blocks), allocate memory for input and output packet buffers, and allocate memory for log buffers. IPSec manager 1516 may also be responsible for IPSec memory maintenance, which may include maintaining a list of available SAD entries, maintaining a hash table of active outbound SAD entries, maintaining a hash table of active inbound SAD entries, and maintaining a hash table of SPD indexes to security policy search table indexes. IPSec manager 1516 may also parse an SAD entry into a packet-processing block and a key information block and copy both blocks to memory, and update an NPU security policy search table with selectors and the associated SAD address. IPSec manager 1516 may also perform soft time lifetime tracking of IPSec outbound security associations. IPSec manager 1516 may also gather and process log entries created by IPSec engine 104 (FIG. 1) and perform path maximum transmission unit (PMTU) processing for IPSec outbound tunnels.

In one embodiment, security policy search table subsystem 1518 may perform security policy checks on outbound and inbound packets. security policy search table subsystem 1518 may provide an interface to IPSec manager 1516 to receive notifications of new policies including, for example, selectors, an action and a tag prepended to outbound packets. security policy search table subsystem 1518 may return an index (e.g. a unique identifier) for the search table entry. security policy search table subsystem 1518 may receive notifications to remove a search table entry based on a search table index, and receive notification to update a tag in the search table entry based on search table index.

IPSec slow path software stack 1500 may also include network processor (NP) slow path handler module 1520 to handle network processor slow path exceptions. NP slow path handler module 1520 interfaces with ICMP handler module 1522 when PMTU messages are returned on an outbound IPSec packet. NP slow path handler module 1520 may interface with IPSec manager 1516 to report ICMP PMTU messages for outbound IPSec packets to IPSec manager 1516. IPSec manager 1516 may use this information to update the PMTU values for the outbound SA associated with an ICMP message.

IKE module 1514 may perform an IKE for IPSec engine 104 (FIG. 1) and in one embodiment, IKE module 1514 may use policy manager 1506 to obtain the policy information to negotiate a security association for itself and subsequently for IPSec engine 104. Policy manager 1506 may maintain the security policy database (SPD), and may provide an administrator application to add, modify and delete policies. Each policy may be added to the SPD that is maintained by policy manager 1506 and used by IKE 1514. Each policy may provide an action to either bypass, drop or process an IP packet based on its IP source and destination address, and port and protocol information. IP address, protocol and ports can be wildcards (i.e., don't cares). IP addresses may include a range or subnet mask. An inbound and outbound IPSec security association pair may be created for each policy that specifies IPSec processing. The security association may be created using manual keys, or the policy may provide the requisite information needed to establish an IKE security association as well as an inbound and outbound security association for IPSec.

Policy manager 1506 may provide selector information to IPSec manager 1516 as each policy is added. As SAD entries are created, policy manager 1506 may provide them to IPSec manager 1516 along with the policy (including an SPD index to the selector information) they are associated with. Policy manager 1506 may notify IPSec manager 1516 when security policies and SAD entries are deleted. Policy manager 1506 may include the SPD index with SAD entries so that IPSec manager 1516 may determine which SAD entry is associated with each policy. Policy manager 1506 may request an SPI number from IPSec manager 1516 for each inbound IPSec security association prior to its creation. The SPI numbers for inbound security associations may represent a memory address where the inbound security association is stored. This may allow IPSec engine 104 to avoid a SA look-up for inbound IPSec packets.

Policy manager 1506 may also process requests from IPSec manager 1516 to refresh outbound security associations due to soft lifetime expirations. In addition, policy manager 1506 may process notifications from IPSec manager 1516 about security associations that have terminated due to hard lifetime expirations. Policy manager 1506 may also determine whether to refresh SAD entries that have terminated due to a hard lifetime expiration.

Policy manager 1506 may provide selector information to IPSec manager 1516 as each policy is added. As the SAD entries are created, policy manager 1506 may provide them to IPSec manager 1516 along with the policy (e.g., an index to the selector information) they are associated with. Policy manager 1506 may notify IPSec manager 1516 when security policies and SAD entries are deleted.

IPSec slow path software stack 1500 may also include TCP/IP module 1516 to interpret IP data and network driver 1528 to interface with a network processor such as NP 102 (FIG. 1). IPSec slow path software stack 1500 may also include kernel 1524 to separate the driver elements from other modules of software stack 1500. Although IPSec manager 1516 is illustrated above kernel 1524, in an alternate embodiment, IPSec manager 1516 may be located below kernel 1524.

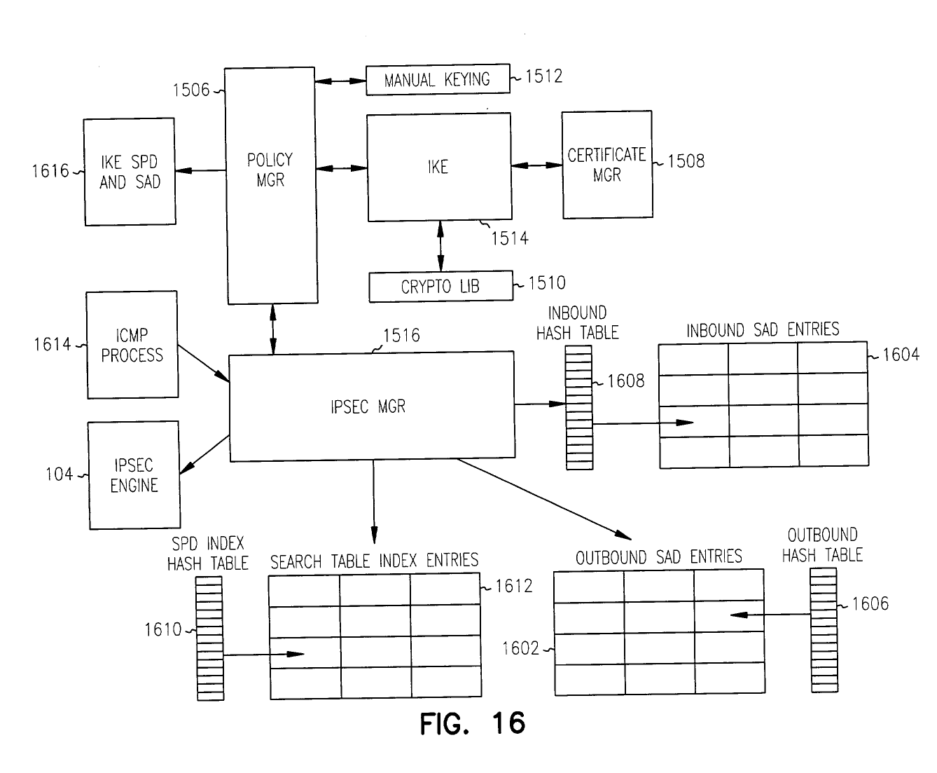

FIG. 16 is a functional overview illustrating the operation of an Internet key exchange (IKE) module and an IPSec manager in accordance with an embodiment of the present invention. IPSec manager 1516 is illustrated at the center of the slow path functionality for IPSec engine 104. Other software modules that are involved in the IPSec functionality may communicate with IPSec manager 1516. IPSec manager 1516 may perform initialization, memory management, outbound SAD time lifetime tracking, log event processing, and PMTU processing for IPSec engine 104. IPSec manager 1516 may be responsible for initialization of IPSec engine 104. IPSec manager 1516 may use interface 108 (FIG. 1) to initialize memory for IPSec engine 104. IPSec manager 1516 may initialize a memory controller, clear memory, and load IPSec firmware to the hardware. IPSec manager 1516 may also perform any other hardware initialization such as initialization of a semaphore controller, input and output packet handlers, and embedded processors. IPSec manager 1516 may receive a configuration file to aid in the initialization. IPSec manager 1516 may also maintain a memory map for IPSec engine 104, may allocate and track the memory used by the SAD entries, and may log entries for IPSec engine 104. It may also allocate memory for input and output packet buffering. The configuration file may describe the amount of memory for each memory interface, the maximum number of SAD entries to support, the size of the input and output buffers for each channel, and the maximum number of logs entries to support.

Also illustrated in FIG. 16 is outbound hash table 1606 pointing to outbound SAD entries 1602, inbound hash table 1608 pointing to inbound SAD entries 1604, and SPD index hash table 1610 pointing to search table index entries 1612. Outbound SAD entries 1602 may contain many of outbound SADs 600 (FIG. 6). Inbound SAD entries may contain many of inbound SADs 1000 (FIG. 1).

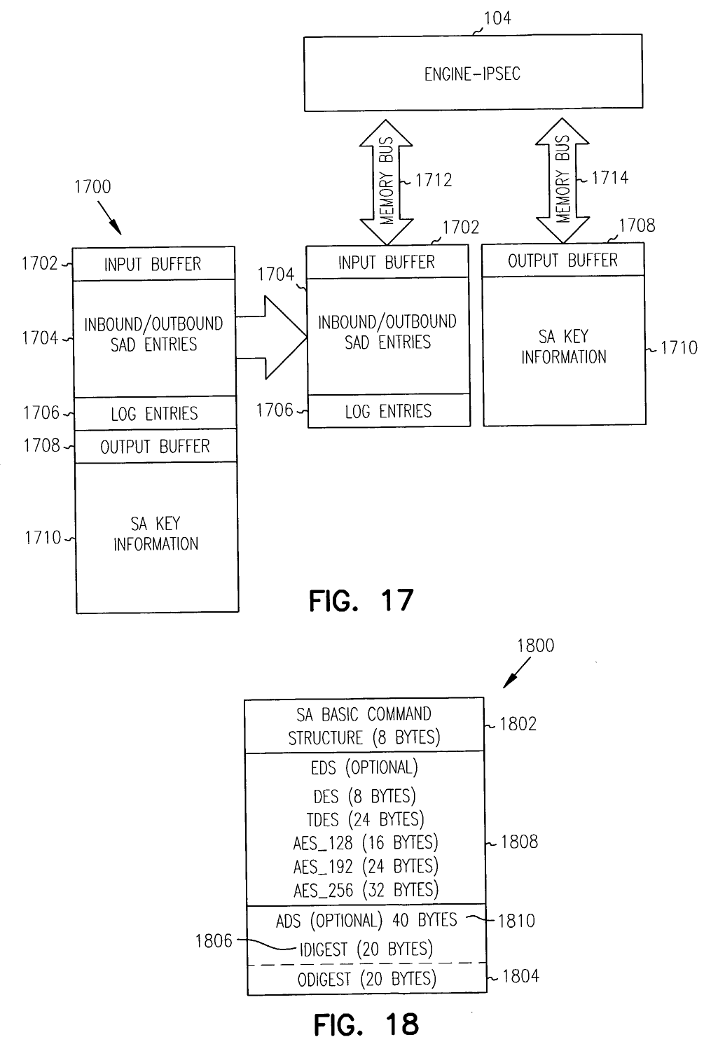

FIG. 17 is an example of an IPSec memory management table and physical memory allocation in accordance with an embodiment of the present invention. IPSec memory management table 1700 may identify input buffer block 1702, inbound/outbound SAD entries block 1704, log entries block 1706, output buffer block 1708 and SA key information block 1710. A configurable amount of memory, such as memory 118 (FIG. 1), allocated to IPSec engine 104 may be reserved for use by IPSec manager 1516, which may maintain SAD entries 1602, 1604 (FIG. 16). In one embodiment, two blocks of memory may be reserved for SAD entries, the first block 1704 may contain SAD information for packet processing and second block 1710 may contain the key information of the SA. Each block of IPSec memory management table 1700 may be allocated on an 8 byte boundary. SA packet-processing block 1704 may be 80 bytes and SA key information block 1710 may be 80 bytes. A pointer to the key information in second block 1710 of the memory may be pre-allocated to the SAD entries in first block 1704. IPSec engine 104 may access the memory through one or more memory busses 1712, 1714.

FIG. 18 is an example of a SA key information block in accordance with an embodiment of the present invention. SA key information block 1800 may be suitable for use as SA key information block 1710 (FIG. 17) although other key information blocks are also suitable. SA key information block 1800 may include SA basic command structure block 1802, optional EDS block 1808, optional ADS block 1810, O-Digest 1804 and I-Digest 1806. IPSec manager 1516 may be responsible for creating command structure block 1802, and may be responsible for creating O-Digest block 1804 and I-Digest block 1806 from a hash key.

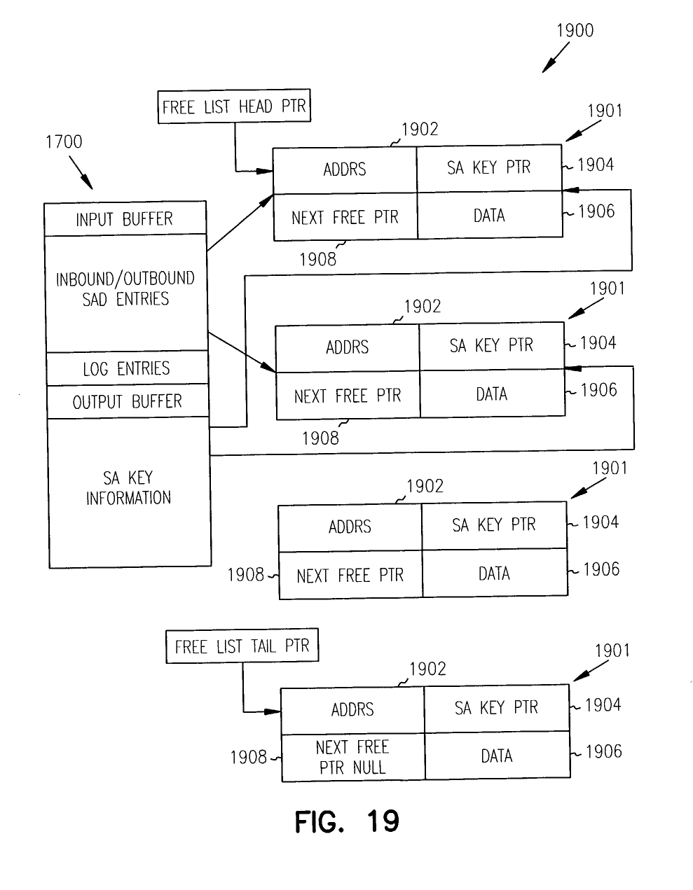

FIG. 19 is an example of a SAD free memory list in accordance with an embodiment of the present invention. IPSec manager 1516 may create SAD free memory list 1900 during initialization. IPSec manager 1516 may populate free memory list 1900 with the number of SAD entries that may be supported by the system. Each entry 1901 may correspond with an available SAD and may contain packet processing entry address 1902 and correlating SAD key information entry address 1904. Each entry 1901 may also provide a predetermined number of bytes of available data 1906 that may be initialized when the entry is removed from free memory list 1900. SAD free memory list 1900 may also include pointer 1910 to the head of the list and each entry 1901 may include pointer 1908 to indicate the next free memory entry 1901. In addition to the SAD free memory list, two hash tables (one for active inbound SAD entries and one for active outbound SAD entries) may be created.

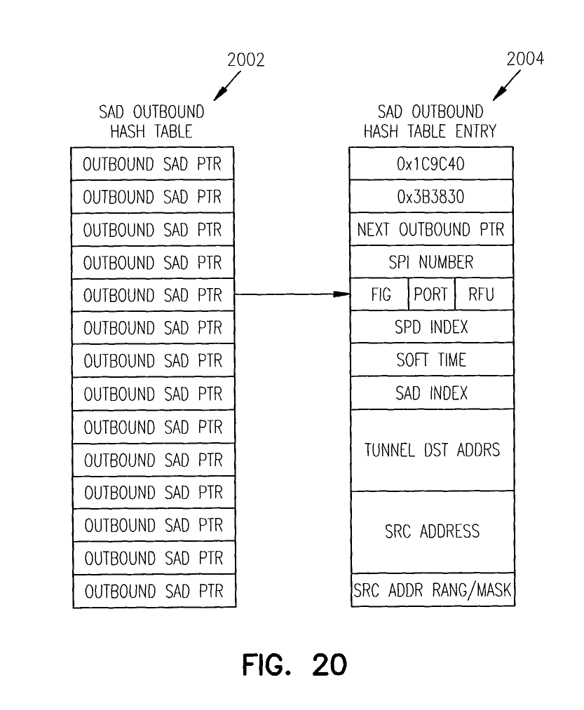

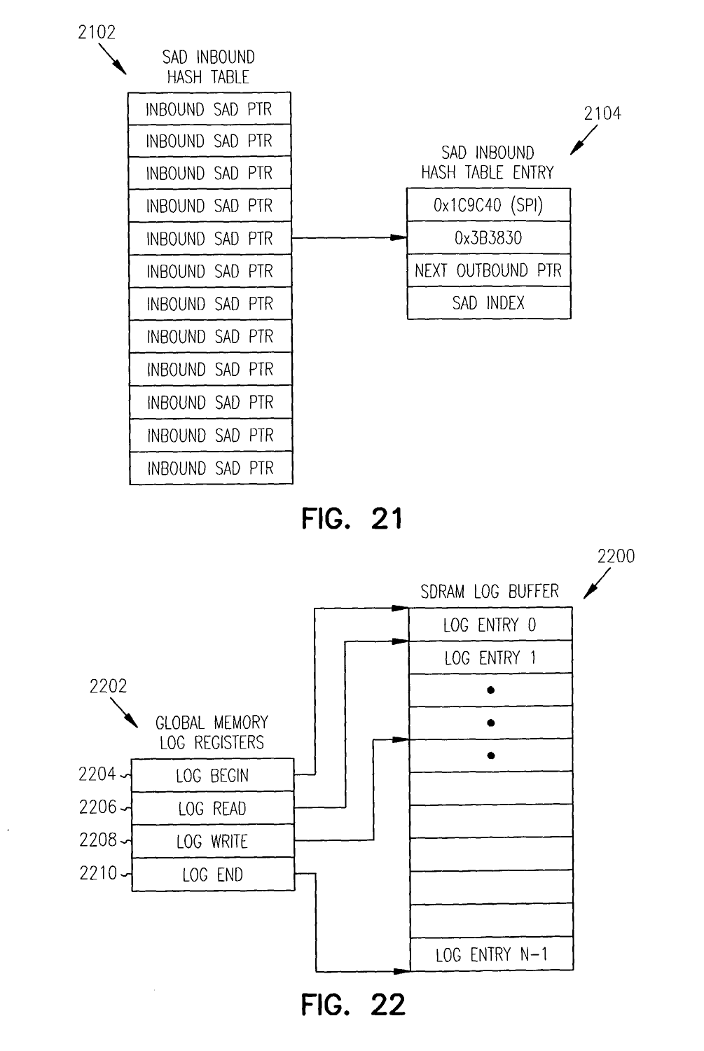

FIG. 20 is an example of an SAD outbound hash table in accordance with an embodiment of the present invention. FIG. 21 is an example of an Inbound Hash Table in accordance with an embodiment of the present invention. When a new SAD entry is to be established, the entry may be removed from free memory list 1900, initialized and added to either outbound hash table 1606 (FIG. 20) or inbound hash table 1608 (FIG. 21). Outbound has table 1606 is comprised of outbound SAD pointers 2002 indicating the location of associated outbound hash table entry 2004. Inbound has table 1608 is comprised of inbound SAD pointers 2102 indicating the location of associated inbound hash table entry 2104. Outbound hash table entry 2004 and inbound hash table entry 2104 illustrate examples of some of the information that may be included in hash table entries.

When an SAD entry is no longer required or valid, it may be removed from the appropriate hash table and added to the end of free memory list 1900. When new outbound security associations are established, policy manager 1506 may notify IPSec manager 1516. Policy manager 1506 may pass a copy of its SAD entry to IPSec manager 1516. IPSec manager 1516 may return an SAD index (e.g., the SAD entry address) that can be used to reference the SAD entry in future communications. In addition IKE 1514 may provide an IKE SAD index that can be used to reference the SAD entry in future communications. The SPI number can also be used to reference the SAD entry in future communications. The value used to reference the SAD entry after it has been passed to IPSec manager 1516 may be implementation specific, and may be based on the IKE implementation. The SAD entry may contain the SPD index that the SAD entry is associated with. The SPD index may be used by IPSec manager 1516 to associate the SAD entry with a previously received security policy (e.g., selector information). IPSec manager 1516 may parse the SAD entry into two separate SA blocks (e.g., packet processing block 1704 and key information block 1710). IPSec manager 1516 may then remove an entry from the front of SAD Free memory list 1900, and add it to outbound hash table 1606 based on the SAD entry address for the SAD entry. When the entry is added to outbound hash table 200, the entry it may include the two IPSec engine 104 address. In addition, other pertinent information taken from the SAD entry received from policy manager 1506 may be copied into outbound entry 2004. SAD outbound hash table entry 2004 may include an address for IPSec engine 104, and an IPSec SA packet processing data pointer, and a pointer to IPSec SA key information data. SAD outbound hash table entry 2004 may also include SoftTime (4 bytes) indicating a soft time threshold value, and TunnelDest (16 bytes) indicating an IP Destination Address which may be used for PMTU processing to verify ICMP message is for SAD entry. SAD outbound hash table entry 2004 may also include SourceAddr (16 bytes) indicating an IP Source Address used for PMTU processing to identify the hosts that need to be notified of new PMTU value. SAD outbound hash table entry 2004 may also include an IP Source Range/Mask (4 bytes) which may be used for PMTU processing to help identify the hosts that need to be notified of new PMTU value. If number of hosts (based on range/mask) is limited, the IPSec manager may notify ICMP process 1614 to notify each host of new PMTU value. Otherwise, the offending hosts will be notified the next time they exceed the PMTU.

SAD outbound hash table entry 2004 may also include an SPD Index (4 bytes) which may denote the security policy maintained by policy manager 1506 that the SAD entry is associated with. SAD outbound hash table entry 2004 may also include an SPI Number (4 bytes) and an IKE SAD index (4 bytes), which may be used by the policy manager to track its local copy of a SAD entry.

SAD outbound hash table entry 2004 may also include an IPSec Protocol (1 byte), which may be used for PMTU processing to verify an ICMP message is for the SAD entry. SAD outbound hash table entry 2004 may also include flags (1 byte) including a source protocol flag, which is set if the source IP address is an IPv6 address, and is cleared if source IP address is an IPv4 address. The source protocol flag may be valid when TunnelDest is IPv6. When TunnelDest is IPv6, SourceAddr could be IPv6 or IPv4. If TunnelDest is IPv4, SourceAddr can only be IPv4. The flags may also include a tunnel Protocol Flag which is set if TunnelDest is an IPv6 address and is cleared if TunnelDest is an IPv4 address. The flags may also include an IKE Active Flag, which may be set when IKE 1514 has been notified to refresh the SAD entry. The flags may also include a Mask Flag to indicate when the Range/Mask field is a mask and is cleared when Range/Mask is a Range.

The next free entry pointer value from the free memory list may be used as the next outbound SA entry pointer in the outbound hash table for entries that hash to the same table index. IPSec manager 1516 may then copy the two blocks into the IPSec memory at the addresses specified from the Outbound Hash Table entry. In processing a new outbound SA, IPSec manager 1516 may notify NPU 102 security policy search table subsystem with the new address of the packet-processing block along with the search table index that the new SAD entry is associated with.

When policy manager 1506 deletes a SAD entry, it may notify IPSec manager 1516 that the SAD entry is no longer needed. IPSec manager 1516 may locate the SAD entry in outbound hash table 1606. When the correct SAD entry is located, IPSec manager 1516 may remove it from outbound hash table 1606 and may then add it to the end of SA free memory list 1900.

When IPSec manager 1516 identifies (due to a log entry obtained from IPSec engine 104) that an outbound SAD entry that has expired, it may notify policy manager 1506 via the SAD index. Policy manager 1506 may remove the entry from its database, and determine if the SAD entry should be refreshed. IPSec manager 1516 may notify IPSec manager 1516 when the SAD entry has been removed. When IPSec manager 1516 identifies (e.g., due to a log entry obtained from IPSec engine 104 or through its own SAD time lifetime tracking) that an outbound SAD entry has exceeded its soft lifetime threshold, it may notify policy manager 1506 via the SAD index. Policy manager 1506 may refresh the SAD entry and notify IPSec manager 1516 when the new SAD entry has been established. Policy manager 1506 may then notify IPSec manager 1516 to remove the old SAD entry.

Prior to establishing new inbound security associations, policy manager 1506 may obtain an SPI number from IPSec manager 1516. The address of the SA packet-processing block may be returned to policy manager 1506 as the SPI number (see FIG. 21). When the new inbound SAD entry has been established, policy manager 1506 may send it to IPSec manager 1516 to be parsed into the two separate SA blocks, and loaded into a memory allocated to IPSec engine 104. When the SPI number is requested from policy manager 1506, IPSec manager 1516 may remove the next entry from the inbound free memory list 1900 and add the entry to Inbound Hash Table 1608. When a new inbound SAD entry is received from policy manager 1506, IPSec manager 1516 may return a SAD index that can be used to identify the SAD entry in future communications. In addition IKE 1514 may provide an IKE SAD index that may be used to reference the SAD entry in future communications. The SPI number can also be used to reference the SAD entry in future communications. The value used to reference the SAD entry after it has been passed to IPSec manager 1516 may be implementation specific, and may be based on the IKE implementation. The SAD entry may contain the SPD index that the SAD entry is associated with. The SPD index may be used by IPSec manager 1516 to associate the SAD entry with a previously received security policy (selector information). IPSec manager 1516 may then locate the entry in inbound hash table 1608 and update its information. Inbound hash table entry 2104 may contain a pointer to IPSec SA packet processing data pointer which may also the SPI number. Inbound hash table entry 2104 may also include a pointer to IPSec SA key information data and an IKE SAD index (4 bytes), which may be used by policy manager 1506 to track its local copy of a SAD entry. Inbound hash table entry 2104 may also include an SPD Index (4 bytes) to denotes the security policy maintained by policy manager 1506 that the SAD entry is associated with.

IPSec manager 1516 may then parse the inbound SAD entry from policy manager 1506 into the two separate SA blocks required by the IPSec engine. It may then copy the two separate blocks into the IPSec memory at the addresses specified in the inbound hash table entry.

When an inbound IPSec packet is received and related to an SAD entry that has expired, IPSec manager 1516 may be notified via a log message. IPSec manager 1516 may then notify policy manager 1506 and policy manager 1506 may determine if the SAD entry should be refreshed based on the policy associated with the SAD entry. Policy manager 1506 may notify IPSec manager 1516 when an inbound SAD entry is released. IPSec manager 1516 may remove the SAD entry from inbound hash table 1608 and add it the end of the inbound free memory list 1900.

When an inbound SAD entry is refreshed prior to its hard lifetime expiration, there may be a period when two inbound SAD entries exist for the same tunnel. However, there will not be a problem identifying which SAD entry is to be used for an individual packet since each packet may identify its SAD entry based on the SPI number in its IPSec header.

To prevent an old SAD entry from being used while it is being replaced, IPSec manager 1516 may implement the following process. When IPSec manager 1516 receives notification from policy manager 1506 that an inbound SAD entry is deleted, IPSec manager 1516 may remove the SAD entry from the inbound hash table and add it to a temporary queue for a duration of, for example, a few hundred milliseconds. This may permit a packet that is still using the old inbound tunnel to complete as long as the old inbound tunnel hard lifetimes have not yet expired. After the duration has expired, IPSec manager 1516 may set the SPI number in the SA Packet-Processing block of the SAD entry that resides, for example, in a memory of IPSec engine 104 to a predetermined value, such as 0xFFFFFFFF. IPSec manager 1516 may then move the SAD entry from the temporary queue to the end of SA free memory list 1900. Once the SA entry on the free memory list propagates to the front of the empty list, it can be allocated to a new SA. When this occurs, the old inbound SA in IPSec memory may be over written. The SPI number contains the SAD entry address, which may be on a 16-byte boundary, and therefore the 4 least significant bits may contain a rotating count that is incremented each time (wraps at 15) the SAD address is reused. This may prevent an old packet from being mistaken as a packet for the new SAD entry when the old SAD entry is eventually replaced. If an old packet is received, it may fail the SPI check, and may be dropped. A log message may be generated.

The next free entry pointer value from free memory list 1900 may be used as the next SA inbound entry pointer in the outbound hash table for entries that hash to the same table index. IPSec manager 1516 may then copy the two blocks into IPSec memory at the addresses specified in outbound hash table entry 2004.

The information required for each IPSec SA entry may be included in the SA entry passed to IPSec manager 1516 from policy manager 1506. The only exception is the hard time lifetime parameter. The SA entry received from policy manager 1506 may include the hard time lifetime parameter as an offset in seconds to the current time. IPSec manager 1516 may then read the current time from a timer. The timer may be a 32-bit, 1 HZ clock that may be reset whenever the IPSec engine 104 is initialized. This will help eliminate wrap around conditions. IPSec manager 1516 may add the an offset to the current time and store the result in the SA packet-processing block as the hard time lifetime value. The IPSec processes may then only need to read the current time from its timer and compare it with the hard time lifetime value in the current SA entry that is being processed.

IPSec manager 1516 may manage the security policy search table indexes along with the SAD and SPD entries they are associated with. Policy manager 1506 thus may provide a SPD index with each security policy (selector information) that it passes to IPSec manager 1516. IPSec manager 1516 may notify NPU 102 security policy search table subsystem to update its search table with the new selectors along with an invalid SAD address. The invalid SAD address may be the SPD index with the msb set (SPD index |0x80000000). If the msb of a SAD address is set, the firmware may drop the packet and generate a log entry with the invalid SAD address (SPD index) to IPSec manager 1516. IPSec manager 1516 may use the SPD index to notify policy manager 1506 that the SAD entries need to be established for the security policy denoted by the SPD index. A search table manager process operating on NPU 102 may return a search table index to IPSec manager 1516, which may be used by IPSec manager 1516 to identify the search table entry that will need to be updated when the SAD entry is established.

IPSec manager 1516 may maintain a SPD hash table to track the association between the SPD index from policy manager 1506, and the search table index from NPU 102 search table manager process. Each entry in the hash table will include the SPD and search table index. The hash entry location may be based on the SPD index. When the SAD entries are established, policy manager 1506 may provide them to IPSec manager 1516 with a SAD index as well as the SPD index the SAD entry is associated. IPSec manager 1516 may first allocate a new SAD entry, add it to the outbound hash table and update memory with the new SAD entry. IPSec manager 1516 may then locate the search table index in the hash table, and pass it along with the associated SAD address to the security policy search table subsystem of NPU 102 so that it can update its search table.

IPSec manager 1516 may reserve memory for I/O packet buffers, which may be at least 64K Bytes of IPSec memory per channel. The I/O packet buffers may be used for buffering packets as they are received. IPSec manager 1516 may also reserve at least 64K Bytes of IPSec memory per channel to buffer packets before they are sent back to NPU 102. IPSec manager 1516 may also initialize IPSec hardware registers that are provided to facilitate the buffering.

NPU 102 may be responsible for performing a security policy check for inbound and outbound packets. The inbound selector may be identical to the outbound selectors with the source and destination IP and port addresses reversed. The inbound security policy check may be performed after IPSec engine 104 has processed an IPSec packet, and may result with an action that indicates that the packet should have been processed. A drop or bypass indication may cause NPU 102 to drop the packet. The outbound security policy check may be performed prior to sending an outbound packet to IPSec engine 104 and may result in an action that indicates process, bypass or drop. If the process action is indicated, NPU 102 may prepend the SAD address to the beginning of the outbound packet.

For inbound policies, IPSec manager 1516 may be responsible for providing NPU 102 with the security policy selector information along with a process, bypass or drop action indication. When a new policy is created, the policy manager may notify IPSec manager 1516 with the selector information. IPSec manager 1516 may notify NPU 102 security policy search table subsystem (SPSTS) with the selector information and an action indication to process, bypass or drop packet. The SPSTS may return a search table index that may be used to delete the policy at a later time if necessary.

For outbound policies, IPSec manager 1516 may be responsible for providing NPU 102 with the security policy selector information and its corresponding outbound SAD address for NPU 102's security policy search table. When a new policy is created, the policy manager may notify IPSec manager 1516 with the selector information. IPSec manager 1516 may notify NPU 102 security policy search table subsystem (SPSTS) with the selector information and an invalid SAD address (bit 31 is set) that indicates the security policy that is associated with the selector information. An SPSTS of NPU 102 may update its security policy search table and return a search table index to IPSec manager 1516. IPSec manager 1516 may use the search table index to notify the SPSTS of the address of a new or refreshed SAD entry that is associated with the search table entry. IPSec manager 1516 may also use the search table index to notify the SPSTS of a security policy entry that has been deleted.

When an IPSec process receives an outbound packet with an invalid SAD entry address prepended to it, it may create a log entry (with the invalid SAD address) for IPSec manager 1516. IPSec manager 1516 may read the log entry and notify policy manager 1506 to create the SAD entries for the policy indicated by the invalid SAD address included with the log entry.

IPSec manager 1516 maintains a hash table of active outbound SAD Entries. Each entry may contain a subset of information that is in the SAD entries, plus the SA IPSec memory addresses (SA packet-processing block and SA key information block). Included with this information is the soft time lifetime threshold. The hash table may be traversed so that each entry can be checked for the soft time lifetime expiration. The current time may be checked with the soft time lifetime in the local SAD entry. The soft time lifetime in the local SAD entry may be set relative to its own timers. If the soft time is exceeded, IPSec manager 1516 may notify policy manager 1506 to refresh the SA.

FIG. 22 shows examples of log registers in accordance with an embodiment of the present invention. A configurable amount of memory may be reserved by IPSec manager 1516 to maintain the list of log entries 2200. The memory may be reserved for a maximum number of log entries that may be specified in the configuration file. Each log entry may be the same size as specified by the largest log entry that can be created. Global register file may contain log pointers 2202 that may be accessible by host processor 110 (FIG. 1) as well as channel firmware operation on IPSec engine 104. Log entries 2200 may be created by each IPSec process and stored in IPSec memory. The log entries may be read from IPSec memory by IPSec manager 1516 and processed. The log entries may also contain, for example, error and statistical information.

In one embodiment, IPSec engine 104 may provide four global hardware registers 2202 that may be memory mapped and accessible by channel processors of IPSec engine 104 as well as the host processor 110 via PCI interface 108. IPSec manager 1516 may use Log Read pointer 2206 to remove log entries from the log buffer, and the IPSec channel processes may use LogWrite pointer 2208 to add log entries to the log buffer. IPSec processes may obtain a LogWrite semaphore before they can use the LogWrite pointer 2208. The IPSec processes may signal an interrupt whenever a critical log or a threshold of non-critical logs has been added to log buffer 2200. Critical logs may, for example, include SAD expirations and PMTU exceptions that should be handled immediately. Non-critical logs may include statistical and error information. Host processor 110 may signal IPSec manager 1516 (e.g., via a callback) that log entries are available and IPSec manager 1516 may read and process the log entries.

In one embodiment, Log Begin 2204 may point to a beginning of Log Buffer in SDRAM (e.g., on an 8-byte boundary) of IPSec engine 104. Log Read 2206 may point to a next available log entry that has not yet been processed (e.g., on an 8-byte boundary). LogWrite 2208 may point to a next available log entry that will be updated (e.g., on an 8-byte boundary). LogEnd 2210 may point to end of log buffer (e.g., on an 8-byte boundary). Log Read 2206 and LogWrite 2208 may be set to Log Begin 2204 when they exceed this value. IPSec manager 1516 may initialize the log pointers.

IPSec manager 1516 of slow path software stack 1500 (FIG. 15) may also process PMTU exceptions. The IPSec SA packet-processing block of outbound SAD 600 (FIG. 6) may include field 616 (FIG. 6) to store the PMTU value for the tunnel. IPSec manager 1516 may initialize the field to the PMTU for a router. The IPSec processes may verify the length of the IP packet (after adding the additional headers) with the PMTU value in the SAD entry. If the PMTU is exceeded, a log message may be created for IPSec manager 1516 so that IPSec manager 1516 can send an ICMP message back to the offending host to adjust its PMTU.

In some cases, a PMTU exception may not noticed until after the packet leaves the gateway (tunnel source). This may occur if the packet length is within the PMTU of the gateway, but exceeds the PMTU of a router in the path to the tunnel destination gateway. In this case, the IPSec router may receive PMTU ICMP messages. As ICMP PMTU messages are received by NPU 102 for IPSec tunneled packets, NPU 102 may direct the packets to its slow path process, which may in turn direct the packet to IPSec manager 1516. IPSec manager 1516 may parse the ICMP packet for IP destination address, IPSec protocol and SPI number. IPSec manager 1516 may use this information to locate the appropriate SAD entry in outbound SA hash table 1606. If the SAD entry identifies a single host, IPSec manager 1516 may send the host an ICMP message to adjust its PMTU. IPSec manager 1516 may then update the PMTU information in the IPSec SAD entry. This may allow the IPSec processes to catch the next PMTU violation and correctly identify the offending host if multiple hosts are using the IPSec tunnel. When a SAD entry is refreshed, its PMTU value may be reset to the PMTU of the router. If the tunnel continues to use routers with a smaller MTU value, the PMTU value in the SAD entry may be adjusted again.

Software stack 1500 (FIG. 15) also includes network processor slow path handler 1520 to address PMTU processing of outbound IPSec Packets. The network process may pass ICMP messages to slow path handler 1520. If slow path handler 1520 determines that the ICMP message is a PMTU message for an IPSec packet, it may notify IPSec manager 1516, providing it the ICMP message.

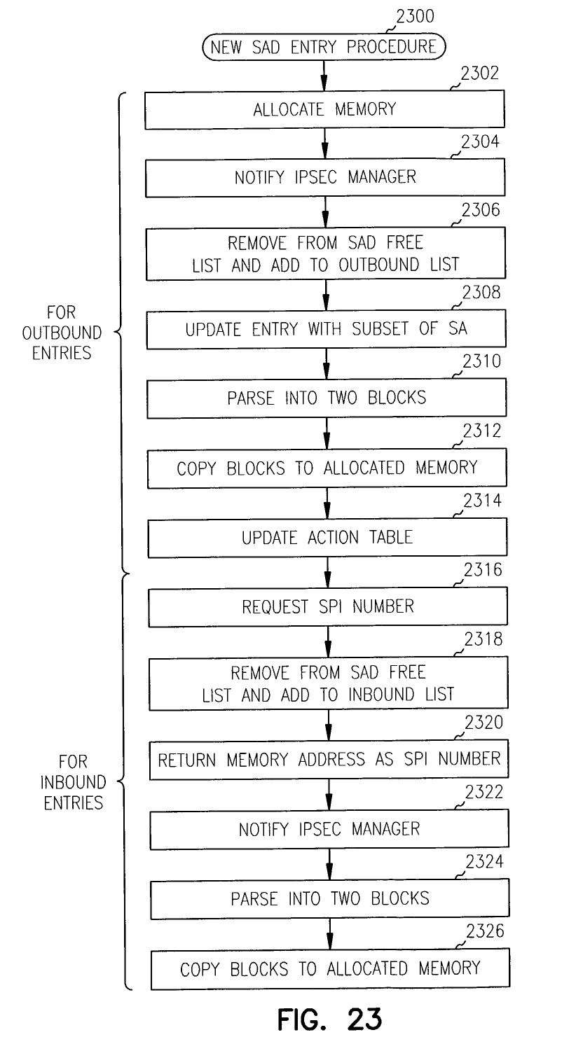

FIG. 23 is a flow diagram of a procedure for adding a new SAD entry in accordance with an embodiment of the present invention. Procedure 2300 may be performed with modules of software stack 1500 (FIG. 15) including IPSec manager 1516 and policy manager 1506 in conjunction with IPSec engine 104 (FIG. 1) and network processor 110 (FIG. 1), although other elements may be suitable for performing procedure 2300. Operations 2302 through 2314 are directed outbound SAD entries while operations 2316 through 2326 are directed to adding an inbound entry. Although the individual operations of procedure 2300 are illustrated and described as separate operations, one or more of the individual operations may be performed concurrently and nothing requires that the operations be performed in the order illustrated.

In operation 2302, an outbound SA entry is established by allocating two separate blocks of available memory from the SAD free memory list to an SAD entry. The blocks may include an SA packet-processing block and an SA key information block. Both blocks may be allocated during initialization. The SA packet-processing block may maintain the pointer to the SA key information block. In operation 2304, policy manager 1506 may notify IPSec manager 1516 that a SA has been established. In operation 2306, IPSec manager 1516 may remove the next entry from the SAD free memory list and add the entry to the outbound list. In operation 2308, IPSec manager 1516 may update the entry added to the outbound list with a subset of the SA entry passed by policy manager 1506. In operation 2310, IPSec manager 1516 may parse the SAD entry from policy manager 1506 into two separate blocks for use by IPSec engine 104 (FIG. 1). IN operation 2312, IPSec manager 1516 may copy each block to memory allocated for IPSec engine 104 at the addresses specified in the SA outbound list. The SA packet-processing block may contain a pointer to the SA key information block. In operation 2314, IPSec manager 1516 may update an action table entry in IPSec memory with the SA packet-processing address contained in the SA outbound entry. The action table index may be obtained from the SA outbound entry to allow IPSec manager 1516 to update the correct action table entry.

In operation 2316, policy manager 1506 may request an SPI number from IPSec manager 1516 to establish an inbound SAD entry. In operation 2318, IPSec manager 1516 may remove the next entry from the SA free memory list and add it to the SA inbound list. In operation 2320, IPSec manager 1516 may return the memory address (i.e., the address for SA packet-processing block) to policy manager 1506 as the SPI number. In operation 2322, after the inbound SA entry is established, policy manager 1506 may notify IPSec manager 1516.

In operation 2324, IPSec manager 1516 may locate the SAD entry previously added to the SA inbound list and parse the SAD entry from policy manager 1506 into the two separate blocks for use by IPSec engine 104. In operation 2326, IPSec manager 1516 may copy the two blocks to the memory allocated to IPSec engine 104 at the addresses specified in the SA inbound entry. The SA packet-processing block may contain a pointer to the SA key information block.

The foregoing description of specific embodiments reveals the general nature of the invention sufficiently that others can, by applying current knowledge, readily modify and/or adapt it for various applications without departing from the generic concept. Therefore such adaptations and modifications are within the meaning and range of equivalents of the disclosed embodiments. The phraseology or terminology employed herein is for the purpose of description and not of limitation. Accordingly, the invention embraces such alternatives, modifications, equivalents and variations as within the spirit and scope of the appended claims.

What is claimed is:

1. A processing system comprising:
a security engine to process inbound and outbound security packets received from a network processor; and
a processor to execute a software stack comprising a policy manager and a security manager, the policy manager to at least administer a security policy database (SPD), the security manager to allocate memory for the security engine.

2. The system of claim 1 wherein the security manager also initializes the security engine and performs exception logging for the security engine.

3. The system of claim 1 wherein the SPD includes security policies indicating an action to perform on a packet comprising one of either a process, bypass, or drop action based on either source or destination addresses, and the policy manager creates a security association pair for each security policy to specify security packet processing.

4. The system of claim 1 wherein the policy manager provides security association database (SAD) entries to the security manager as for each additional security policy, the policy manager also providing an SPD index to correlate security policies with the SAD.

5. The system of claim 1 wherein the security manager allocates memory to the security engine for input and output packet buffering, allocates memory for the SAD entries, allocates memory for key information for each security association and allocates memory for log entries.

6. The system of claim 5 wherein the security manager receives a configuration file describing the memory allocated and maintains a memory map for the security engine.

7. The system of claim 3 wherein the security manager checks a hash table for the security association to determine when a soft time-lifetime threshold has been exceeded and notifies the policy manager to refresh the security association when the lifetime threshold has been exceeded.

8. The system of claim 3 wherein the security engine creates log entries that contain error and statistical information, including security association expirations and packet maximum transmission unit (PMTU) violations, wherein when one of the log entries indicates an expiration of one of the security associations, the security manager notifies the policy manager to refresh the security association.

9. The system of claim 1 wherein the security engine creates log entries for packet maximum transmission unit (PMTU) violations, and wherein when of the log entries indicates a PMTU violation, the security manager generates an Internet control message protocol (ICMP) message for sending to a host device.

10. A security management system comprising:
a policy manager to establish security association database (SAD) entries from configuration information defining a number of security associations; and
a security manager to parse the SAD entries into an SA packet processing block and an SA key information block for use by a security engine.

11. The system of claim 10 wherein the policy manager generates an SAD-free memory list to include entries identifying addresses of memory available for the SAD entries, and the security manager removes an entry from the SAD free memory list when one of the SAD entries is established.

12. The manager of claim 10 wherein SAD entries are either inbound SAD entries or outbound SAD entries, and wherein prior to establishing an inbound SAD entry, the policy manager requests a security policy index (SPI) number from the security manager, and the security manager provides a memory address of a security association packet processing block as the SPI number.

13. The manager of claim 12 wherein the security manager updates an action table in a memory of the security engine with a SA packet processing address of an outbound SAD entry.

14. The manager of claim 10 wherein the SA packet processing block includes a pointer to the SA key information block.

15. A method of managing security packet processing with a security manager, the method comprising:
allocating memory to a security processing system for packet processing; and
performing exception logging associated with security packet processing.

16. The method of claim 15 wherein allocating is performed by the security manager, the security manager comprised of a software module executed on a host processor in communication with the security packet processing system.

17. The method of claim 15 further comprising initializing the security processing system, wherein initializing comprises:
receiving configuration information defining a number of security associations to be used for processing security packets; and
generating security association database (SAD) entries from the configuration information for each security association.

18. The method of claim 17 wherein initializing further comprises copying security firmware into the memory allocated to the security processing system.

19. The method of claim 17 wherein, for each security association, source and destination addresses, and key information for processing security packets are received from a policy manager.

20. The method of claim 17 wherein initializing further comprises generating an SAD free memory list to include addresses of memory available for the SAD entries and the key information.

21. The method of claim 17 wherein initializing further comprises generating hash tables to indicate active inbound SAD entries and active outbound SAD entries.

22. The method of claim 15 wherein allocating memory comprises allocating memory to the security processing system for input and output packet buffering.

23. The method of claim 15 wherein allocating memory comprises allocating memory for inbound and outbound security association database (SAD) entries.

24. The method of claim 15 wherein allocating memory comprises allocating memory for key information for security associations.

25. The method of claim 15 wherein allocating memory comprises allocating memory for log entries.

26. The method of claim 15 further comprising receiving a configuration file to describe amounts of memory allocated.

27. The method of claim 15 further comprising maintaining a memory map for the security processing system.

28. The method of claim 15 wherein a network processor performs a security policy check for inbound and outbound security packets, and
wherein the method further comprises:
receiving security policy selectors from a policy manager when a new inbound security policy is created; and
managing a security policy search table that includes the security policy selectors.

29. The method of claim 28 wherein the security policy check verifies whether source and destination addresses for the inbound and outbound security packets are within a range indicated by a security association.

30. The method of claim 28 further comprising providing a network processor with an action indication in response to the security policy check, the action indication comprising one of either a process, bypass, or drop action.

31. The method of claim 15 wherein the security processing system creates log entries that indicate packet maximum transmission unit (PMTU) violations, and when of the log entries is a PMTU violation, the method includes generating an Internet control message protocol (ICMP) message for sending to a host.

32. The method of claim 15 wherein performing exception logging comprises tracking soft time lifetimes of a security association by checking a hash table to determine when a soft time lifetime threshold has been exceeded, and notifying a policy manager to refresh the security association when the soft time lifetime threshold has been exceeded.

33. The method of claim 15 wherein the security processing system creates log entries that contain error and statistical information, and wherein performing exception logging comprises reading, processing and removing the log entries.

34. The method of claim 33 wherein when one of the log entries indicates expiration of a security association, and the method further includes notifying a policy manager to refresh the expired security association.

35. A method of managing security associations (SA) for processing security packets comprising:
establishing security association database (SAD) entries from configuration information defining security associations;
generating an SAD free memory list to include entries identifying memory available for the SAD entries; and
removing an entry from the SAD free memory list when an SAD entry is established.

36. The method of claim 35 further comprising parsing the SAD entry into an SA packet processing block and an SA key information block for use by a security packet processing system, wherein the SA packet processing block includes a pointer to the SA key information block.

37. The method of claim 35 wherein SAD entries are either inbound SAD entries or outbound SAD entries, and wherein prior to establishing an inbound SAD entry, the method comprises requesting a security policy index (SPI) number from a security manager, the security manager providing a memory address of a SA packet processing block as the SPI number.

38. The method of claim 37 further comprises updating an action table in a memory of the security processing system with a SA packet processing address of one of the outbound SAD entries.

39. A computer readable medium having program instructions stored thereon for managing security packet processing that when executed within a digital processing device, result in:
allocating memory for security packet processing by a security processing system; and
performing exception logging associated with security packet processing.

40. The computer readable medium of claim 39 wherein the instructions when executed further result in initializing the security processing system by:
receiving configuration information defining a number of security associations for use in processing the security packets; and
generating security association database (SAD) entries from the configuration information for each security association.

41. The computer readable medium of claim 40 wherein the configuration information includes, for each security association, source and destination addresses, correlating and key information for processing security packets.

42. The computer readable medium of claim 39 wherein allocating memory includes:
allocating memory to the security processing system for input and output packet buffering;
allocating memory for inbound and outbound security association database (SAD) entries;
allocating memory for key information for each security association; and
allocating memory for log entries.

43. The computer readable medium of claim 39 wherein performing exception logging includes checking a hash table for a security association to determine when a lifetime threshold has been exceeded and notifying a policy manager to refresh the security association when the lifetime threshold has been exceeded.

44. The computer readable medium of claim 39 wherein performing exception logging includes creating log entries that contain error and statistical information, including security association expirations and packet maximum transmission unit (PMTU) violations.

45. The computer readable medium of claim 44 wherein when one of the log entries indicates an expiration of one of the security associations, the security manager notifies the policy manager to refresh the security association.

46. The computer readable medium of claim 44 wherein when of the log entries indicates a PMTU violation, the security manager generates an Internet control message protocol (ICMP) message for sending to a host.

47. A processing engine comprising:
a streaming interface to receive inbound and outbound security packets for security processing;
a crypto-engine to process the security packets; and
a communication interface to interface with memory allocated to the processing engine.

48. The processing engine of claim 47 wherein security packets processed by the crypto-engine are transmitted by the streaming interface, and the communication interface receives information from security association database entries and key information for processing the security packets.

49. A security packet processing system comprising:
memory to store a software stack comprising a policy manager and a security manager; and
a processor to execute the software stack, wherein when executed, the policy manager to at least administer a security policy database (SPD), the security manager to allocate memory for a security engine for processing inbound and outbound security packets.

50. The system of claim 49 wherein the policy manager, when executed, provides security association database (SAD) entries to the security manager as for each additional security policy, the policy manager also providing an SPD index to correlate security policies with the SAD.

51. The system of claim 49 wherein the security manager, when executed, allocates memory to the security engine for input and output packet buffering, allocates memory for the SAD entries, allocates memory for key information for each security association and allocates memory for log entries.
